(19) United States
(12) Patent Application Publication
(10) Pub. No.: US 2026/0300619 A1
(43) Pub. Date: Oct. 1, 2026

(54) METHOD AND APPARATUS FOR ENCODING AND DECODING COMMON MESSAGE FORMAT - EFFICIENT

(71) Applicant: L3Harris Technologies, Inc., Melbourne, FL (US)

(72) Inventors: Kyle MITCHELL, Greenville, TX (US); Krissa ROSS, Greenville, TX (US)

(21) Appl. No.: 19/097,026

(22) Filed: Apr. 1, 2025

(51) Int. Cl. G06F 40/221; G06F 40/143; G06F 40/149

(52) U.S. Cl. CPC G06F 40/221; G06F 40/143; G06F 40/149

(57) ABSTRACT

A method comprises: storing a document type definition (DTD) and an extensible markup language (XML) representation compatible with standard XML, and which includes element start tags, element end tags, and element values having integer values assigned thereto by the DTD; accessing the XML representation and the DTD, and encoding the integer values for the element start tags and the element values, but not the element end tags, into quadbits that form an extensible binary representation of the XML representation, wherein each quadbit includes one or more half-bytes of binary values, a sum of the one or more half-bytes is equal to a corresponding integer value, and a full half-byte indicates a follow-on half-byte for the corresponding integer value, which provides extensible encoding for each quadbit; packaging the quadbits for the integer values into data packets; and transmitting a data stream including the data packets over a data channel.

### STATEMENT OF GOVERNMENTAL INTEREST

This invention was made with government support under Contract No. FA8555-19-D-0005 awarded by the United States Air force. The government has certain rights in the invention.

### TECHNICAL FIELD

This invention relates to the transmission of data across communications media, and more particularly to methods and architectures for communicating XML-based data.

### BACKGROUND

Transmitted information for current computer systems is often formatted using the extensible mark-up language (XML) standard. The XML standard provides a powerful and efficient language through which to communicate a wide range of data and information in a standard format that can be recognized across a wide variety of different computing platforms. As such, XML provides a flexible and common framework for improving compatibility of data transfer between systems. A disadvantage to XML is that the XML standard was not designed for communication efficiency, which is needed in certain environments such as narrow or limited bandwidth channels. The relative inefficiency of communicating XML-formatted data causes problems with devices such as cell phones, dial-up modems, and other low or narrow bandwidth systems.

FIG. 1 (prior art) provides a block for a prior art system 150 in which XML formatted data is communicated through a network. Block 104 represents an XML formatted document, data or information that is to be communicated by one system to another through a network 102 and reconstructed or received as XML formatted document, data or information, as represented by block 106. The network 102 can be made up of any of a wide variety of communications systems and devices, both wired and wireless, that ultimately provide communication connectivity between two systems. As shown in FIG. 1, the technique for communicating this XML formatted document 104 is to represent the text as ASCII or Unicode data words, to transmit this ASCII or Unicode data from a first system through the network as represented by line 108, and to receive this ASCII or Unicode data from the network by a second system as represented by line 110.

The ASCII and Unicode standards are two well-known textual coding schemes for representing text characters as sets of binary bits. The ASCII standard provides an 8-bit data byte that represents a character set of 256 commonly used characters, including the alpha-numeric and punctuation symbols. The Unicode standard basically provides an extension of ASCII with similar encoding but additional 8-bit bytes representing additional characters for coverage of languages other than English. ASCII and Unicode being intended for the encoding/transfer of textual data are inefficient at encoding/transferring numerical (integer and/or floating point) values. They are inefficient methods for the encoding of numbers in that each numerical digit as well as included decimal points each consume at least 8-bits.

Existing binary data encoding schemes often use inflexible fixed bit messages or field groups that are not easily extensible or not extensible in a backwards/forwards compatible manner. Creating a situation where they cannot be modified without requiring a coordinated all-at-one change to every system using a given version of the encoding scheme.

### BRIEF DESCRIPTION OF THE DRAWINGS

FIG. 1 (prior art) is a block diagram for a prior art system in which XML formatted data is communicated directly through a network as ASCII encoded data.

FIG. 2 is a block diagram for an embodiment according to the present invention where common message format (CMF) parsers are utilized for conversion between XML-based ASCII or Unicode encoded data to binary CMF (including CMF-Efficient (CMF-E)) data for network communications.

FIG. 3A is a block diagram for a system that includes a CMF parser for CMF-E according to the present invention.

FIG. 3B is a block diagram for a CMF parser for CMF-E according to the present invention.

FIG. 4 shows examples of various quadbits of CMF-E.

FIG. 5 shows an example document type definition (DTD) for CMF-X that uses/defines context sensitive tagging.

FIG. 6 shows an example XML snippet based on the DTD of FIG. 5.

FIG. 7 is an example graphical view of CMF-E context sensitive tagging established by the DTD of FIG. 5 and the XML snippet of FIG. 6.

FIG. 8 shows an example graphical view of non-context sensitive tags used by CMF-B for the XML snippet of FIG. 6.

FIG. 9 shows an example DTD for CMF-E that is useful for describing an enumerable string construct of CMF-E.

FIG. 10 is a block diagram of an example system that includes a sending system and a receiving system configured to implement CMF-E encoding and decoding.

FIG. 11 is a flowchart of an example method of CMF-E encoding integers as quadbits, performed by a sending system.

FIG. 12 is a flowchart of an example method of CMF-E encoding a character string in accordance with an enumerable string construct, performed by a sending system.

FIG. 13 is a flowchart of an example method of CMF-E decoding/converting a binary representation of a first XML representation that was encoded into the binary representation and then transmitted by a sending system, performed by a receiving system.

FIG. 14 is a block diagram of an example controller configured to perform operations described herein

### DESCRIPTION

### Overview

In an embodiment, an apparatus comprises: data storage to store a document type definition (DTD) or an extensible markup language (XML) schema definition (XSD) and an extensible markup language (XML) representation compatible with standard XML, and which includes element start tags, element end tags, and element values having integer values assigned thereto by the DTD; a parser to access the XML representation and the DTD, and encode the integer values for the element start tags and the element values, but not the element end tags, into quadbits that form an extensible binary representation of the XML representation, wherein each quadbit includes one or more half-bytes of binary values, a sum of the one or more half-bytes is equal to a corresponding integer value, and a full half-byte indicates a follow-on half-byte for the corresponding integer value, which provides extensible encoding for each quadbit; a packager to package the quadbits for the integer values into data packets; and a communication interface to transmit a data stream including the data packets over a data channel.

### EXAMPLE EMBODIMENTS

The Integrated Broadcast Service (IBS) employs a Common Message Format (CMF) to communicate information between different systems. The CMF (referred to simply as “CMF”) presents data in a consistent format across different platforms. CMF provides fully extensible data types and flexible data structures to meet current and future information exchange requirements. CMF presents a single format with a single set of user definable data elements and attributes, but with three possible ways to represent/encode the data. That is, CMF supports three transmission representation types to support transmission across narrowband and wideband mediums. The three transmission types include CMF-XML (CMF-X), CMF-binary (CMF-B), and CMF-Efficient (CMF-E).

CMF-X is a well-formed and “valid” implementation of the XML commercial standard to be utilized primarily on mid to high bandwidth mediums due to its fully character-based implementation. CMF-X, being a true XML implementation, supports the use of commercially available tools (e.g., web browsers) for CMF-X parsing, databasing, and display.

CMF-B is a custom, extensible, binary encoding derivation of the XML tag-based standard and provides efficient transmission through networks, particularly low bandwidth networks where bandwidth and critical timing constraints are encountered, such as in over-the-air (OTA) transmissions. CMF-B is described in U.S. Pat. No. 8,060,652, issued Nov. 15, 2011, which is incorporated herein by reference in its entirety.

Embodiments presented herein are directed to CMF-E and related extensions of CMF-X that support CMF-E. CMF-E is a custom, extensible, binary encoding derivation of the XML tag-based standard. CMF-E is efficient for transmission through networks, particularly low bandwidth networks where bandwidth and critical timing constraints are encountered, such as in OTA transmissions. While similar in some respects to CMF-B, CMF-E provides additional improvements and transmission bandwidth saving over CMF-B, as described herein.

The embodiments directed to CMF-E and the related CMF-X, achieve an efficient dual-representation format and allow for efficient communication of XML-based data through communication media, particularly those with narrow or low bandwidth constraints. The embodiments achieve a dual-representation of the same data that can be seamlessly converted back and forth. The CMF-X data format is fully XML-compliant, ASCII-based, subset implementation of XML that can be used with commercial-off-the-shelf (COTS) tools and is human readable. Due to the tag-based nature of XML and the use of text for all tags and data, CMF-X can be fully extensible and byte-based. The CMF-E data format is preferably an XML-based, compact, binary representation that is efficient for transmission through networks, particularly those where bandwidth and critical timing constraints are encountered, such as in OTA transmissions. As discussed below, binary data constructs of CMF-E provide individual field and package structures that are extensibility equivalent and similar to XML. Further details and embodiments of the present invention are described below. In addition, the APPENDIX included below provides a detailed explanation of the CMF-X, CMF-B, and CMF-E data formats.

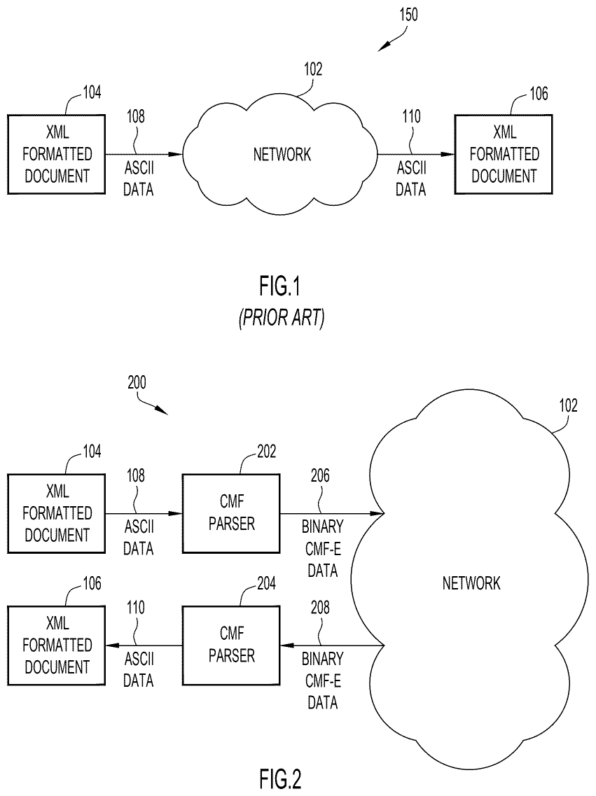

FIG. 2 is a block diagram for an embodiment 200 where CMF parsers 202 and 204 are utilized for conversion between XML-based ASCII encoded data, extended to include/support CMF-E constructs as described below, to binary CMF-E data for communications through network 102. In particular, unlike FIG. 1 (prior art) where ASCII data is packaged and transmitted across network 102, CMF parser 202 converts the XML formatted document (CMF-X) extended to support the CMF-E constructs from ASCII data into binary CMF (CMF-E) data for transmission through network 102, as represented by line 206. This CMF-E data, which is described in further detail below, is extensible. Once passed through network 102, the CMF-E data is received by CMF parser 204, as represented by line 208. CMF parser 204 then converts the CMF-E data back into an XML recognizable ASCII format (CMF-X). As described below, the CMF-E data coding allows for reduced bandwidth requirements by reducing the number of bits that are transmitted. The embodiments are particularly useful for narrow or low bandwidth communication channels, such as those that have a bandwidth or data rate of less than 9600 baud. The embodiments are not limited to communications systems and may be equally applicable to other hardware or software systems and media such as data storage systems, EPROMs, gate arrays, programmable logic devices (PLDs), video devices, audio devices, graphical devices, flash memory, fiber optics, Digital Video Discs (DVDs), and Compact Discs (CDs), amongst other systems in which data is transferred.

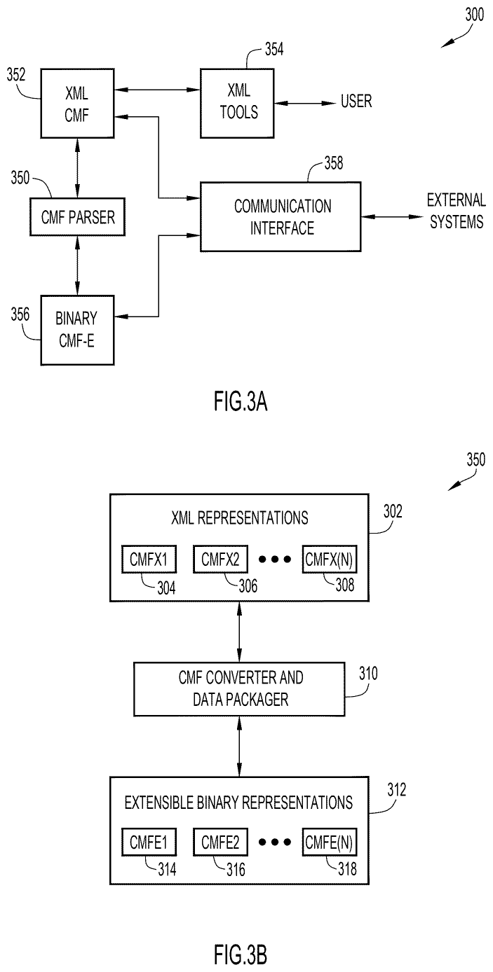

FIG. 3A is a block diagram for a system 300 that includes a CMF parser 350 according to the present invention. Block 352 represents XML formatted CMF data (CMF-X) that includes/supports CMF-E constructs and can be manipulated by a user, as desired, using standard XML tools, as represented by block 354. As discussed in more detailed below, the CMF-X format is compatible with standard XML but does not necessarily implement all aspects of the XML standard. The CMF parser 350 allows for seamless conversion from the CMF-X data to extensible binary CMF data (CMF-E) as represented by block 356. The communications interface 358 can then preferably use the CMF-E formatted data from block 356 for transmission to external systems that also have operational CMF parsers. If desired, the system 300 could also transmit CMF-X data from block 352 to external systems. These less efficient communications may be desirable, for example, where the receiving external system does not have an operational CMF parser or where the bandwidth of the communication channel is large enough to handle the larger bit-rates needed to transfer XML formatted data. Additionally, the CMF parser 350 could also provide an XML-equivalent form of the data via other standard interfaces such as the Document Object Model (DOM).

FIG. 3B is a block diagram for a CMF parser 350 according to the present invention. The CMF parser 350 includes a CMF converter and data packager 310 that converts data between the two formats and creates data packets, as discussed in further detail in the APPENDIX below. In another example, the data packager may be external to CMF parser 350. XML representations 302 represent the extensible mark-up language protocols and formats supported by the CMF-X data coding scheme, extended to include/support CMF-E constructs. This CMF-X data is preferably compatible with standard XML. Blocks 304, 306 . . . 308 represent individual CMF-X representations CMFX1, CMFX2 . . . CMFX(N). Similarly, extensible binary representations 312 represent the extensible binary protocols and formats that are supported by the CMF-E data coding scheme. This CMF-E data format is preferably constructed so as to make data transmissions more efficient. Blocks 314, 316 . . . 318 represent individual CMF-E representations CMFE1, CMFE2 . . . CMFE(N) that correspond to CMF-X representations. In operation, the CMF parser 350 takes the CMF-X data from block 352 and uses a mapping or conversion scheme within CMF converter and data packager 310 to convert this CMF-X data to CMF-E data provided to block 356. Going the other way, the CMF parser 305 takes the CMF-E data from block 356 and uses a mapping or conversion scheme within CMF converter and data packager 310 to convert this CMF-E data to CMF-X data provided to block 352. The XML representations 302 and correlating extensible binary representations 312 are utilized to provide this conversion. The CMF parser 350, therefore, provides seamless dual-representation functionality.

The embodiments also provide a unique approach for declaration of binary data types and tags via a standard XML Document Type Definition (DTD) file which utilizes the XML attribute construct to identify and declare elements; assign numbers to element tag names; and identify an element's type definitions as well as element characteristics such as value ranges, accuracy ranges, defined reportable units, and reporting path specific characteristics. This differs from utilizing tokenization during parse processing of a data stream to identify the components of the equivalent XML structure within the binary equivalent and to identify tags and tag names in that for this invention the attributes within the DTD file identify the structure components.

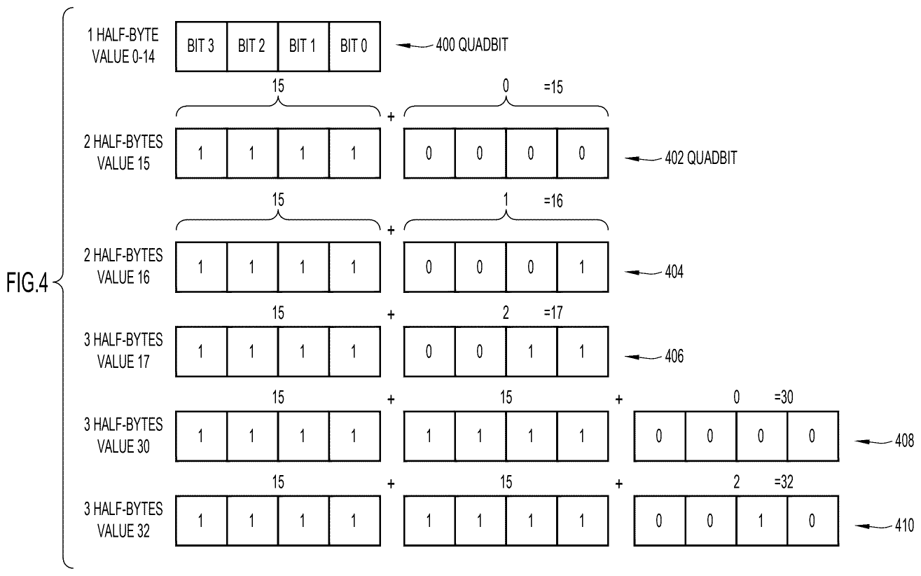

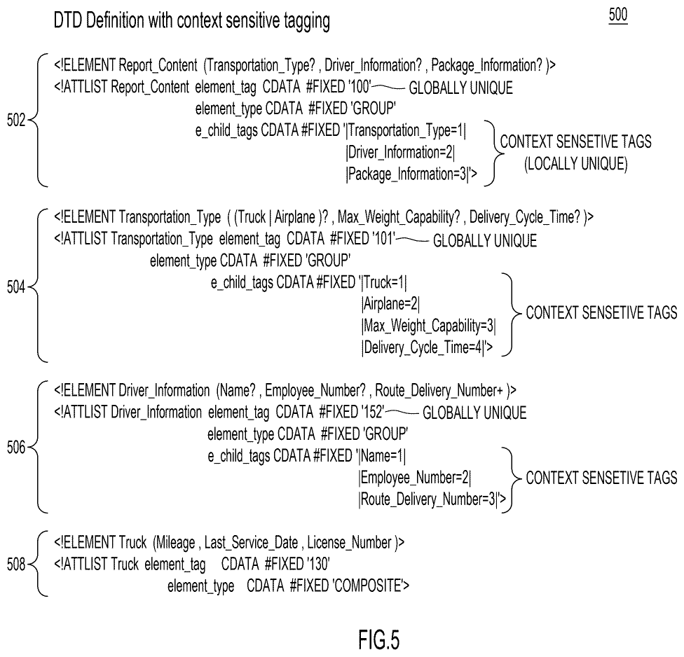

A CMF specification, which has been attached as an APPENDIX below, further describes the embodiments described above and in connection with FIGS. 4-13 below. CMF-E introduces several CMF encoding constructs that convey data in a more bandwidth efficient manner compared to CMF-X. The encoding constructs maintain the fully extensible nature of existing CMF constructs while using fewer bits/bytes to do so, thereby saving considerable bandwidth. The encoding constructs include context sensitive tagging, quadbit integers, and enumerable strings. The encoding constructs are described below.

The quadbit construct is now described. The term “quadbit” may be represented equivalently as “QuadBit” and “QUADBIT.” The quadbit construct leverages a unique mechanism to indicate that an integer value extends into further bit fields rather than dedicating an entire bit per byte to indicate this, as is done in CMF-B. Quadbit encoding encodes an integer value into a quadbit representation (simply referred to as a “quadbit”). Quadbit encoding is used for all CMF-E tags, and also for CMF-E elements having e_field_types defined as (i) e_field_type=quadbit_enumerated used for passing enumerated values assigned to character strings as quadbit integer values, and (ii) e_field_type=quadbit_integer used for passing other integer values, where “e_” indicates CMF-E. The quadbit is based on a unit that is a half-byte (i.e., a 4-bit field), has a self-defining length, and does not use a termination bit. The size of a quadbit is in half-byte increments. Thus, the quadbit size can be a half-byte, a whole byte, one-and-a-half-bytes, two-bytes, and so on.

Quadbit encoding that produce the quadbit uses an additive concept when crossing half-byte boundaries in the quadbit, as opposed to a concatenation-of-bits concept. That is, each half-byte value of the quadbit is added to a following half-byte value of the quadbit, if/when the following half-byte exists. Thus, a quadbit that has a single half-byte can take on single half-byte values 0-14 in decimal (0000, 0001, 0010, thru 1110). In order to avoid the use of a termination bit, the full “1111” half-byte (i.e., a half-byte with all 4 bits set=“1”) (i) indicates a value=“15” decimal, and (ii) always indicates another half-byte to follow. Thus, the full half-byte indicates to add another half-byte value to a current total for the field. Accordingly, the value=15 is encoded into the quadbit “1111 0000” (or 15+0=15).

Similarly, values 16-29 are encoded as full-byte quadbits “1111 0001” (15+1=16), and “1111 0010” (15+2=17) thru “1111 1110” (15+14=29). After 29, another quadbit half byte is added, for a one-and-a-half-byte representation for values 30-44.

While the quadbits provide a smaller representation for small numbers (e.g., values 1-4 fit in one half byte instead of a full byte), the quadbits will begin to grow rapidly for larger numbers. So, although it is fully extensible and can accommodate larger numbers, the quadbit construct is preferably used for integer values when numbers are expected to stay small and not grow.

FIG. 4 shows examples of various quadbits. A generalized half-byte quadbit 400 includes 4-bits that convey a value having a least significant bit (LSB) bit-0 as the right-most bit and a most significant bit (MSB) bit-3 as the left-most bit. Quadbits 402, 404, and 406 convey integer values 15, 16, and 17, respectively, using 2 half-bytes each. Quadbits 408 and 410 convey integer values 30 and 32, respectively, using 3 half-bytes.

Context sensitive tagging is now described. CMF-E further conserves bandwidth by using context sensitive tagging to limit the scope of a child element tag (referred to simply as a “child tag”) to a parent element tag (referred to simply as a “parent tag”) under which the child tag exists, thus reducing the maximum size/value of the integer used to represent the child tag. In this way, CMF-E need not provide a globally unique tag for each element used across a CMF-X document, and may reuse locally scoped child tags. For example, CMF-E provides a context sensitive tag at a GROUP parent level and provides tags for all of the children of that GROUP. The tag assignments are made available for each child element in an “e_child_tags” attribute of the parent. The same element might have a different tag when it is included under another parent.

An example of context sensitive tagging is now described in connection with FIGS. 5-7. FIG. 5 shows an example DTD 500 for CMF-X that uses/defines context sensitive tagging. At 502, 504, 506, and 508, the DTD respectively defines four elements Report_Content, Transportation_Type, Driver_Information, and Truck. At 502, Report_Content is defined as a parent element to child elements Transportation_Type, Driver information, and Package_Information. The DTD includes the descriptor “e_child_tags” to assign context sensitive tags 1, 2, and 3 to child elements Transportation_Type, Driver information, and Package_Information, respectively, in the context of particular parent element Report_Content. The e_child_tags descriptor establishes the context sensitive tagging. Therefore, child elements Transportation_Type, Driver_Information, and Package_Information have tags 1, 2, and 3, when those child elements are children of Report_Content. The tags 1, 2, and 3 are locally unique under the parent, and are not globally unique. That is, the scope of the tags is limited to parent Report_Content, which permits reuse of the same tags 1, 2, and 3 under a different parent.

At 504, Transportation_Type has four child elements Truck, Airplane, Max_weight_Capability, and Delivery_Cycle_Time, for which e_child_tags respectively assigns context sensitive tags 1, 2, 3, and 4. Thus, the three tags 1-3 are reused.

At 506, Driver_Information has three child elements Name, Employee_Number, and Route_Delivery_Number, and to which e_child_tags respectively assigns tags 1, 2, and 3. Thus, the three tags 1-3 are reused a second time.

At 508, Truck has child elements Last_Service_Date and License_Number, to which no context sensitive tags are assigned.

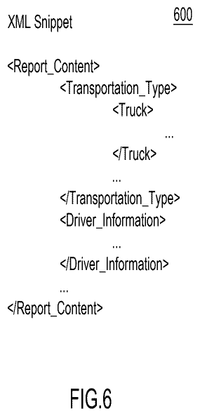

FIG. 6 shows an example XML snippet 600 based on DTD 500. XML snippet 600 establishes the following element nesting hierarchy (i.e., parent-child relationships): Transportation_Type and Driver_Information are each immediately nested under Report_Content; and Truck is immediately nested under Transportation_Type.

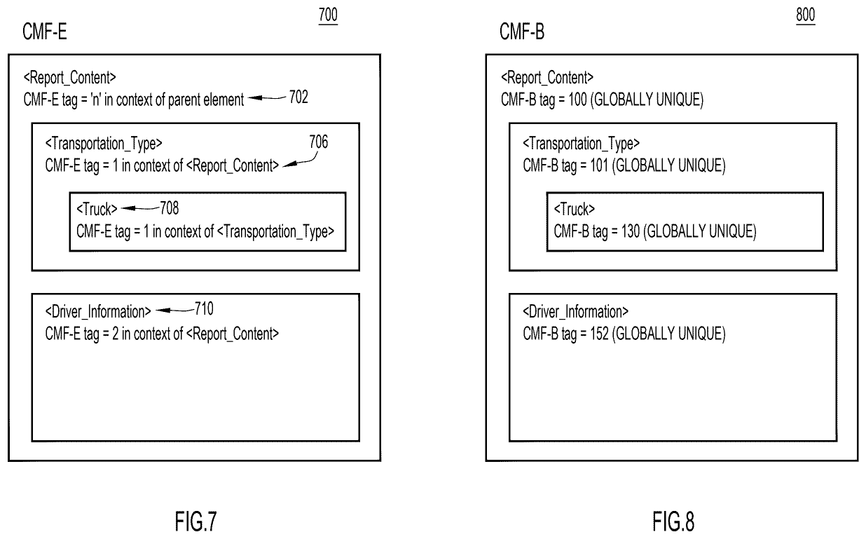

FIG. 7 is an example graphical view 700 of the CMF-E context sensitive tagging established by DTD 500 and XML snippet 600. At 702, Report_Content has a locally unique CMF-E tag=n assigned in the context of an unshown parent element. At 706, Transportation_Type has context sensitive (locally unique) CMF-E tag=1 as a child element in the context/scope of Report_Content. At 708, Truck has context sensitive CMF-E tag=1 as a child element in the context of Transportation_Type. At 710, Driver_Information has context sensitive CMF-E tag=2 as a child element in the context of Report_Content.

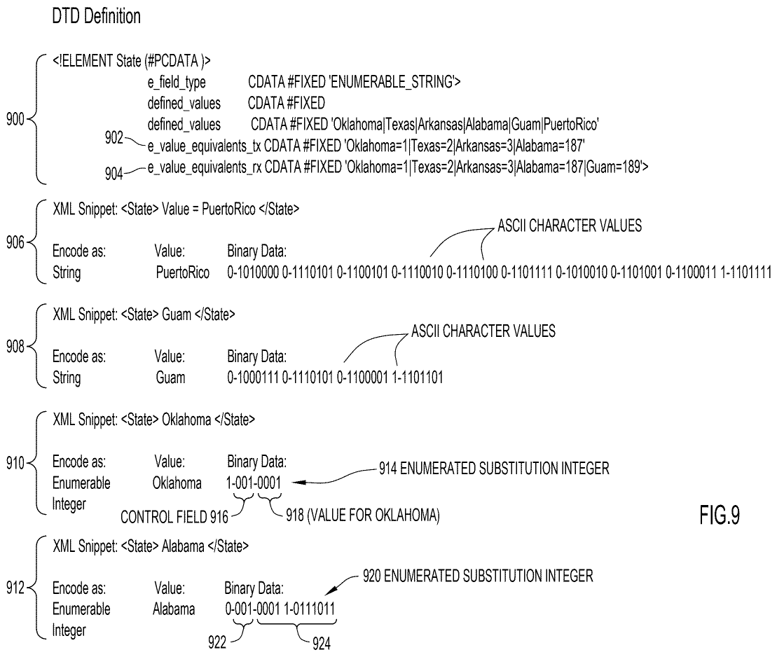

To highlight differences between the context sensitive tags used by CMF-E and non-context sensitive tags used by CMF-B, FIG. 8 shows an example graphical view 800 of non-context sensitive tags used by CMF-B for XML snippet 600. In CMF-B, every tag is globally unique because CMF-B does not offer context sensitive tagging. As shown in FIG. 8, Report_Content, Transportation_Type, Truck, and Driver_Information are assigned globally unique tags 100, 101, 130, and 152, respectively.

The enumerable string construct is now described in connection with FIG. 9. FIG. 9 shows an example DTD 900 for CMF-E that is useful for describing the enumerable string construct. The DTD may be configured on a sending/encoding system (tx) and a receiving/decoding system (rx). That is, the same DTD may be configured on each of the sending and receiving systems. Alternatively, the sending and receiving systems may be configured with different DTDs. (If for example the systems are on differing maintenance schedules or maintained by different vendors.) DTD 900 defines an element State, and its attributes. In accordance with CMF-E, the attributes include an e_field_type ENUMERABLE_STRING, which indicates that a string may be sent as either an integer value or a string (i.e., a series of ASCII character values), depending on later defined attributes. The e_field_type ENUMERABLE_STRING allows for the possibility of substituting an integer value for a string, but not always. The attributes include defined_values, which lists possible strings that can be sent (as either integer values or as strings depending on later attributes).

In accordance with CMF_E, the attribute list further includes an e_value_equivalents_tx statement or list 902 and an e_value_equivalents_rx statement or list 904. “e_value_equivalents_tx” list 902 lists one or more string-to-integer (value) assignments for controlling encoding of strings in the sending system (also referred to as the “sender”). When a string on the e_value_equivalents_tx list is to be sent by the sender, the sender replaces the string with its corresponding value (i.e., the integer assigned to the string in the e_value_equivalents_tx list), and sends the value in place of the string. “e_value_equivalents_rx” list 904 lists one or more string-to-value assignments, which indicates to a receiving system (also referred to a “receiver”) that, when a value on the list is received, the receiver is to convert the value to its corresponding string in the list.

The e_value_equivalents_tx and e_value_equivalents_rx lists separately/respectively control string encoding and decoding in the sending system and the receiving system, and provide for format evolution. For example, when the e_value_equivalents_rx list includes additional string-to-value assignments not included on the e_value_equivalents_tx list of a given DTD, the missing assignments may be easily added to an updated e_value_equivalents_tx list in an updated DTD in order to bring the two lists (and thus the sending system and the receiving system) into conformance with each other. As used herein, the e_value_equivalents_tx list and the e_value_equivalents_rx list may be referred to as an “enumerable string transmit list” and an “enumerable string receive list,” respectively.

In the example of FIG. 9, descriptions 906, 908, 910, and 912 respectively show CMF-E encoding/sending of State values PuertoRico, Guam, Oklahoma, and Alabama responsive to XML snippets that assert those values, based on e_value_equivalents_tx list 902.

At 906, responsive to the XML snippet to send PuertoRico, the sending system parses the e_value_equivalents_tx list for a substitution value for PuertoRico and does not find any such value. That is, there is no e_value_equivalents_tx defined for PuertoRico. Therefore, the encoding system encodes/sends PuertoRico as a String (e.g., a sequence of 7-bit standard ASCII character values).

Similarly, at 908, responsive to the XML snippet to send Guam, the sending system encodes/sends Guam as a String because no e_value_equivalents_tx is defined for it; however, the receiving system is prepared to decode a value 189 for Guam as assigned in e_value_equivalents_rx list 904.

At 910, responsive to the XML snippet to send Oklahoma, the sending system finds a substitution value “1” (which is an integer value) for Oklahoma in e_value_equivalents_tx list 902, and encodes that value “1” into an “enumerated substitution integer” 914 (e.g., “1-001-0001”) for CMF-E. Enumerated substitution integer 914 includes (i) an upper control field 916 with indicator “001” to indicate the value (for the string Oklahoma) was encoded in integer form, and (ii) a lower integer value field 918 that carries the substitution value “0001” for Oklahoma. The “enumerated substitution integer” is distinguished from a standard ASCII character value, which never takes on the same value as the enumerated substitution integer with its leading bits “1-001” or “0-0001.” The enumerated substitution integer construct is extensible. In this case, the enumerated substitution integer “1_001_0001” is substantially more bandwidth efficient than sending the character string as separate ASCII character values or using a CMF-B string representation.

Upon receiving the enumerated substitution integer, the receiving system parses the enumerated substitution integer, recognizes the upper control field value “001” as an indication that the enumerable string carries a enumerable substitution integer value (“0001”) representation of the string value, and uses that value as an index to retrieve the string (Oklahoma) in an e_value_equivalents_rx list of a DTD configured on the receiving system.

At 912, responsive to the XML snippet to send Alabama, the sending system finds a substitution value “187” for Alabama in e_value_equivalents_tx list 902, and encodes that value “187” into an enumerated substitution integer 920 that includes (i) a control field 922 with a value “001” to indicate the enumerated substitution integer, and (ii) an value field 924 extended across first and second bytes that collectively carry the substitution value for “187” for Alabama.

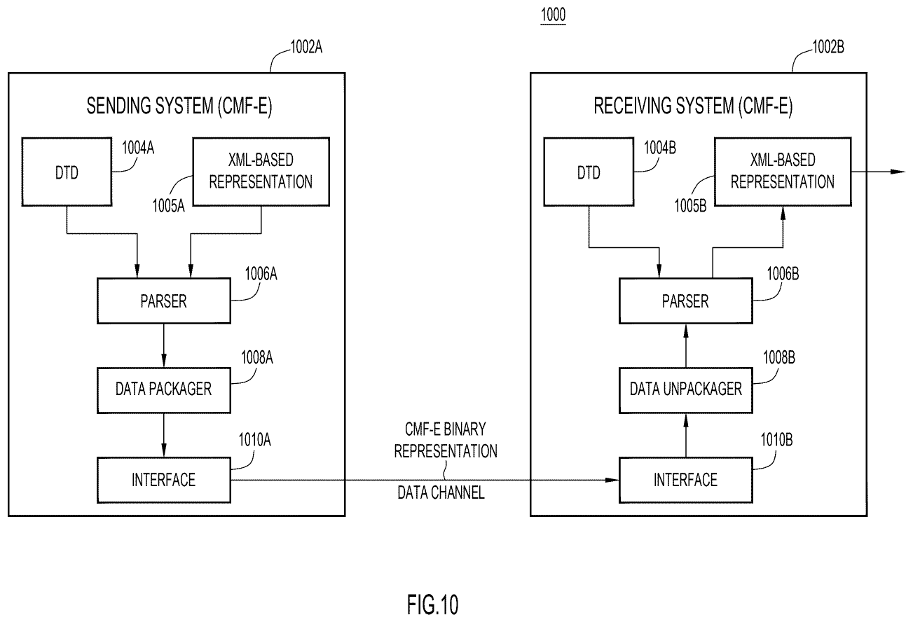

FIG. 10 is a block diagram of an example system 1000 that includes a sending system 1002A and a receiving system 1002B each configured to implement CMF-E based embodiments. For example, sending system 1002A may implement quadbit encoding, context sensitive tagging, and enumerable strings. Sending system 1002A includes memory configured with a CMF-E based DTD 1004A and a CMF-E XML-based representation, a CMF-E parser 1006A, a data packager 1008A, and a communication interface 1010A. CMF-E based DTD 1004A and CMF-E XML-based representation 1005A are each configured according to CMF-E and may be stored in files, for example. CMF-E parser 1006A encodes/converts CMF-E XML-based representation 1005A into a CMF-E binary representation that includes binary representations of the various elements of the XML-based representation. The CMF-E binary representation includes less bits and is more transmission bandwidth efficient than other format types, such as CMF-B. Data packager 1008A packages or packetizes the CMF-E binary representation into a stream of data packets (e.g., Internet Protocol packets or other types of packets) that convey the CMF-E binary representation, and communication interface 1010A transmits the stream of data packets to receiving system 1002B over a data channel.

Receiving system 1002B includes memory configured with a CMF-E based DTD 1004B which may or may not match DTD 1004A, a CMF-E parser 1006B, a data unpackager 1008B, and a communication interface 1010B. Receiving system 1002B may implement quadbit decoding, context sensitive tagging, and enumerable strings. Communication interface 1010B receives the stream of data packets transmitted by sending system 1002A, and provides the same to data unpackager 1008B. Data unpackager 1008B unpacks the data packets to produce the binary representations of the CMF-E binary representation, and provides the same to CMF-E parser 1006B. CMF-E parser 1006B decodes/converts the binary representations of the CMF-E binary representation to a CMF-E XML-based representation 1005B that matches CMF-E XML-based representation 1005A, and provides the CMF-E XML-based representation 1005B as an output to a user. CMF-E XML-based representation 1005B may be stored to a file and presented on a display, for example.

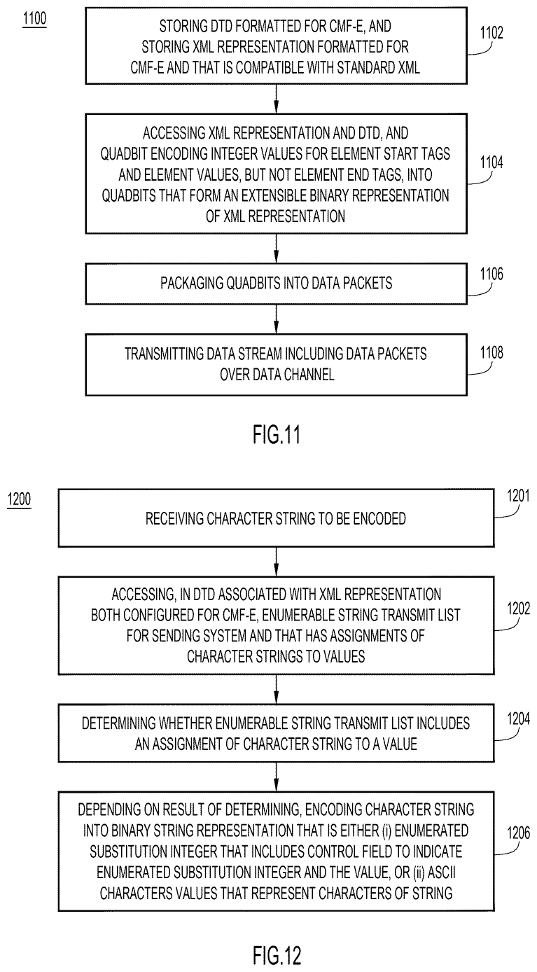

FIG. 11 is a flowchart of an example method 1100 of encoding integers as CMF-E quadbits performed by a sending system.

1102 includes storing a DTD and an XML representation for CMF-E that is compatible with standard XML, and which includes element start tags, element end tags, and element values having integer values assigned thereto by the DTD.

1104 includes accessing the XML representation and the DTD, and encoding the integer values for the element start tags and the element values, but not the element end tags, into quadbits that form an extensible binary representation of the XML representation. Each quadbit includes one or more half-bytes of values, a sum of the one or more half-bytes is equal to a corresponding integer value, and a full half-byte indicates a follow-on half-byte for the corresponding integer value, which provides extensible encoding for each quadbit.

1106 includes packaging the quadbits for the integer values into data packets.

1108 includes transmitting a data stream including the data packets over a data channel.

When the XML representation further includes a character string to which an enumerated value is assigned by the DTD, 1104 includes quadbit encoding the enumerated value into a corresponding quadbit, and 1106 includes packaging the corresponding quadbit for the enumerated value into the data packets.

In an embodiment, the DTD defines a context sensitive tag relationship between a parent element and a child element that is nested under the parent element in the XML representation. The context sensitive tag relationship limits a scope of an integer value assigned to the child element by the DTD to the parent element, such that the integer value is only locally unique under the parent element and is available for unambiguous assignment to other elements of the XML representation that are not under the parent element.

FIG. 12 is a flowchart of an example method 1200 of encoding a character string of an XML representation in accordance with an enumerable string construct of CMF-E, performed by a sending system.

1201 includes receiving the character string to be encoded.

1202 includes accessing, in a DTD associated with the XML representation, an enumerable string transmit list (i.e., the e_value_equivalents_tx list) for the sending system and that has assignments of character strings to (integer) values.

1204 includes determining whether the enumerable string transmit list includes an assignment of the character string to a value.

1206 includes, depending on a result of determining, encoding the character string into a binary string representation that is either (i) an enumerated substitution integer that includes an indicator of the enumerated substitution integer and a value for the character string, or (ii) one or more ASCII characters values to represent the one or more characters. More specifically, 1206 includes, upon determining that the enumerable string transmit list includes the assignment of the character string to the value for the character string, encoding the character string into the enumerated substitution integer that includes the indicator of the enumerated substitution integer and the value for the string. Additionally, 1206 includes, upon determining that the enumerable string transmit list does not include the assignment of the character string to the value, encoding the one or more characters as one or more one-byte ASCII character values.

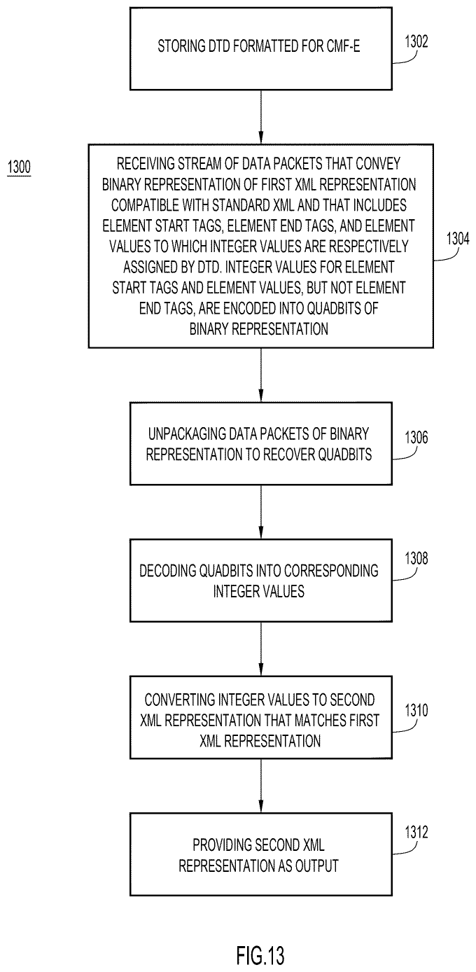

FIG. 13 is a flowchart of an example method 1300 of CMF-E decoding/converting a binary representation of a first XML representation that was encoded into the binary representation and then transmitted by a sending system, performed by a receiving system.

1302 includes storing a DTD formatted according to CMF-E.

1304 includes receiving, over a data channel, a stream of data packets that convey the binary representation of the first extensible markup language (XML) representation. The first XML representation is compatible with standard XML and includes element start tags, element end tags, and element values to which integer values are respectively assigned by the DTD. The integer values for the element start tags and the element values, but not the element end tags, are encoded into quadbits of the binary representation. The binary representation may also encode binary enumerated values that represent characters strings as quadbits.

1306 includes unpackaging (or unpacking) the data packets of the binary representation to recover the quadbits.

1308 includes decoding the quadbits into corresponding ones of the integer values. In addition, when quadbits represent enumerated values for character strings, 1308 includes decoding the quadbits to recover the enumerated values.

1310 includes converting the integer values and the enumerated values to a second XML representation that matches the first XML representation.

1312 includes providing the second XML representation as an output.

In addition, the receiving system parses the binary representation for a binary representation in the form of an enumerated substitution integer having the control field “001.” Upon finding the enumerated substitution integer, the receiving system uses the value in the enumerated substitution integer to retrieve, from an enumerable string receive list (i.e., the e_value_equivalents_rx list) for the receiving system that is in the DTD, a replacement character string to be supplied to the second XML representation.

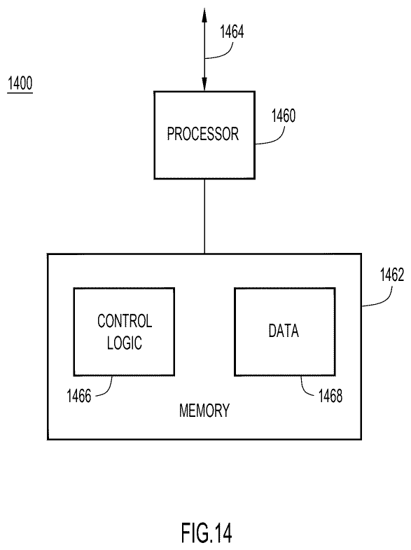

FIG. 14 is a block diagram of an example controller 1400 configured to perform operations (e.g., signal processing operations) described herein. Controller 1400 includes processor(s) 1460 and a memory 1462 coupled to one another. The aforementioned components may be implemented in hardware (e.g., a hardware processor), software (e.g., a software processor), or a combination thereof. Processor(s) 1460 receive information over interfaces 1464 (including network interface units), which may include hardware and/or software interfaces for communicating with other entities and networks wirelessly or through wired links. Interfaces 1464 may include a receiver and a transmitter implemented in hardware and/or software, for example. Memory 1462 stores control software 1466 (referred as “control logic”), that when executed by the processor(s) 1460, causes the processor(s), and more generally, controller 1400, to perform the various operations described herein. The processor(s) 1460 may be a microprocessor or microcontroller (or multiple instances of such components). The memory 1462 may include read only memory (ROM), random access memory (RAM), magnetic disk storage media devices, optical storage media devices, flash memory devices, electrical, optical, or other physically tangible (i.e., non-transitory) memory storage devices. Controller 1400 may also be discrete logic embedded within an integrated circuit (IC) device.

Thus, in general, the memory 1462 may comprise one or more tangible (non-transitory) computer readable storage media (e.g., memory device(s)) including a first non-transitory computer readable storage medium, a second non-transitory computer readable storage medium, and so on, encoded with software or firmware that comprises computer executable instructions. For example, control software 1466 includes logic to implement operations performed by the controller 1400. For example, the logic may implement a parser, data packager, a data unpackager, and portions of interfaces 1464. Thus, control software 1466 implements the various methods/operations described herein.

In addition, memory 1462 stores data 1468 used and produced by control software 1466. Such data may include a DTD and an XML representation.

In some aspects, the techniques described herein relate to an apparatus including: data storage to store a document type definition (DTD) and an extensible markup language (XML) representation compatible with standard XML, and which includes element start tags, element end tags, and element values having integer values assigned thereto by the DTD; a parser to access the XML representation and the DTD, and quadbit encode the integer values for the element start tags and the element values, but not the element end tags, into quadbits that form an extensible binary representation of the XML representation, wherein each quadbit includes one or more half-bytes of binary values, a sum of the one or more half-bytes is equal to a corresponding integer value, and a full half-byte indicates a follow-on half-byte for the corresponding integer value, which provides extensible encoding for each quadbit; a packager to package the quadbits for the integer values into data packets; and a communication interface to transmit a data stream including the data packets over a data channel.

In some aspects, the techniques described herein relate to an apparatus, wherein: the full half-byte further indicates a maximum binary value for a half-byte.

In some aspects, the techniques described herein relate to an apparatus, wherein: the DTD defines a context sensitive tag relationship between a parent element and a child element that is nested under the parent element in the XML representation, wherein the context sensitive tag relationship limits a scope of an integer value assigned to the child element by the DTD to the parent element, such that the integer value is only locally unique under the parent element and is available for unambiguous assignment to other elements of the XML representation that are not under the parent element.

In some aspects, the techniques described herein relate to an apparatus, wherein: the XML representation further includes a character string to which an enumerated value is assigned by the DTD; the parser is configured to quadbit encode the enumerated value into a corresponding quadbit; and the packager is configured to package the corresponding quadbit for the enumerated value into the data packets.

In some aspects, the techniques described herein relate to an apparatus, wherein: the XML representation includes a character string of one or more characters; the parser is configured to encode the character string by: accessing, in the DTD, an enumerable string transmit list having assignments of character strings to values that are integers; determining whether the enumerable string transmit list includes an assignment of the character string to a value; and depending on a result of determining, encoding the character string into a binary string representation that is either (i) an enumerated substitution integer that conveys the value, or (ii) one or more ASCII characters values that represent the one or more characters; and the packager is configured to package the binary string representation into the data packets.

In some aspects, the techniques described herein relate to an apparatus, wherein: the parser is further configured to encode the character string by, upon determining that the enumerable string transmit list includes the assignment of the character string to the value, encoding the character string as the enumerated substitution integer that conveys the value.

In some aspects, the techniques described herein relate to an apparatus, wherein: the enumerable substitution integer is one byte that includes a first field to carry an indicator for the enumerated substitution integer, and a second field to carry the value.

In some aspects, the techniques described herein relate to an apparatus, wherein: the parser is further configured to encode the character string by, upon determining that the enumerable string transmit list does not include the assignment of the character string to the value, encoding the one or more characters as one or more one-byte ASCII character values.

In some aspects, the techniques described herein relate to a method including: storing a document type definition (DTD) and an extensible markup language (XML) representation compatible with standard XML, and which includes element start tags, element end tags, and element values having integer values assigned thereto by the DTD; accessing the XML representation and the DTD, and quadbit encoding the integer values for the element start tags and the element values, but not the element end tags, into quadbits that form an extensible binary representation of the XML representation, wherein each quadbit includes one or more half-bytes of binary values, a sum of the one or more half-bytes is equal to a corresponding integer value, and a full half-byte indicates a follow-on half-byte for the corresponding integer value, which provides extensible encoding for each quadbit; packaging the quadbits for the integer values into data packets; and transmitting a data stream including the data packets over a data channel.

In some aspects, the techniques described herein relate to a method, wherein: the full half-byte further indicates a maximum binary value for a half-byte.

In some aspects, the techniques described herein relate to a method, wherein: the DTD defines a context sensitive tag relationship between a parent element and a child element that is nested under the parent element in the XML representation, wherein the context sensitive tag relationship limits a scope of an integer value assigned to the child element by the DTD to the parent element, such that the integer value is only locally unique under the parent element and is available for unambiguous assignment to other elements of the XML representation that are not under the parent element.

In some aspects, the techniques described herein relate to a method, wherein the XML representation further includes a character string to which an enumerated value is assigned by the DTD, and the method further includes: quadbit encoding the enumerated value into a corresponding quadbit; and packaging the corresponding quadbit for the enumerated value into the data packets.

In some aspects, the techniques described herein relate to a method, wherein the XML representation includes a character string of one or more characters, and the method further includes; encoding the character string by: accessing, in the DTD, an enumerable string transmit list having assignments of character strings to values that are integers; determining whether the enumerable string transmit list includes an assignment of the character string to a value; and depending on a result of determining, encoding the character string into a binary string representation that is either (i) an enumerated substitution integer that conveys the value, or (ii) one or more ASCII characters values to represent the one or more characters; and packaging the binary string representation into the data packets.

In some aspects, the techniques described herein relate to a method, wherein: encoding the character string further includes, upon determining that the enumerable string transmit list includes the assignment of the character string to the value, encoding the character string into the enumerated substitution integer that conveys the value.

In some aspects, the techniques described herein relate to a method, wherein: the enumerated substitution integer is one byte that includes a first field to carry an indicator for the enumerated substitution integer, and a second field to carry the value.

In some aspects, the techniques described herein relate to a method, wherein: encoding the character string further includes, upon determining that the enumerable string transmit list does not include the assignment of the character string to the value, encoding the one or more characters as one or more one-byte ASCII character values.

In some aspects, the techniques described herein relate to a method including: storing a document type definition (DTD); receiving, over a data channel, a stream of data packets that convey a binary representation of an extensible markup language (XML) representation that is compatible with standard XML and that includes element start tags, element end tags, and element values to which integer values are respectively assigned by the DTD, wherein the integer values for the element start tags and the element values, but not the element end tags, are encoded into quadbits of the binary representation, wherein each quadbit includes one or more half-bytes of binary values, a sum of the one or more half-bytes is equal to a corresponding integer value, and a full half-byte indicates a follow-on half-byte for the corresponding integer value; unpack the data packets of the binary representation to recover the quadbits; decoding the quadbits into corresponding ones of the integer values; converting the integer values to the XML representation; and providing the XML representation as an output.

In some aspects, the techniques described herein relate to a method, wherein: the DTD defines a context sensitive tag relationship between a parent element and a child element that is nested under the parent element in the XML representation, wherein the context sensitive tag relationship limits a scope of an integer value assigned to the child element by the DTD to the parent element, such that the integer value is only locally unique under the parent element and is available for unambiguous assignment to other elements of the XML representation that are not under the parent element.

In some aspects, the techniques described herein relate to a method, wherein the XML representation conveyed by the binary representation includes a character string that is assigned to an enumerated value by the DTD and encoded in the binary representation as a quadbit, and the method further includes: decoding the quadbit to recover the enumerated value, and convert the enumerated value to the character string of the XML representation using the DTD.

In some aspects, the techniques described herein relate to a method, wherein the XML representation conveyed by the binary representation includes a character string that is encoded as a binary string representation in the binary representation, and the method further includes: upon determining that the binary string representation indicates that the binary string representation includes a value for the character string, using the value to retrieve the character string from an enumerable string receiver list of the DTD which includes an assignment of the value to the character string.

In some aspects, the techniques described herein relate to a non-transitory computer readable medium encoded with instructions that, when executed by a processor, cause the processor to perform: storing a document type definition (DTD) and an extensible markup language (XML) representation compatible with standard XML, and which includes element start tags, element end tags, and element values having integer values assigned thereto by the DTD; accessing the XML representation and the DTD, and quadbit encoding the integer values for the element start tags and the element values, but not the element end tags, into quadbits that form an extensible binary representation of the XML representation, wherein each quadbit includes one or more half-bytes of binary values, a sum of the one or more half-bytes is equal to a corresponding integer value, and a full half-byte indicates a follow-on half-byte for the corresponding integer value, which provides extensible encoding for each quadbit; packaging the quadbits for the integer values into data packets; and transmitting a data stream including the data packets over a data channel.

In some aspects, the techniques described herein relate to a non-transitory computer readable medium encoded with instructions that, when executed by a processor, cause the processor to perform: storing a document type definition (DTD); receiving, over a data channel, a stream of data packets that convey a binary representation of an extensible markup language (XML) representation that is compatible with standard XML and that includes element start tags, element end tags, and element values to which integer values are respectively assigned by the DTD, wherein the integer values for the element start tags and the element values, but not the element end tags, are encoded into quadbits of the binary representation, wherein each quadbit includes one or more half-bytes of binary values, a sum of the one or more half-bytes is equal to a corresponding integer value, and a full half-byte indicates a follow-on half-byte for the corresponding integer value; unpack the data packets of the binary representation to recover the quadbits; decoding the quadbits into corresponding ones of the integer values; converting the integer values to the XML representation; and providing the XML representation as an output.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

### APPENDIX

### Common Message Format (CMF) Efficient (CMF-E)

This document describes Common Message Format (CMF). CMF is a highly extensible format to be used for the exchange of data over both high and low bandwidth mediums. Particular attention is given to supporting low bandwidth mediums.

This document provides an explanation of the structure, construction, data conventions, and maintenance procedures followed to utilize the CMF. This document assumes the reader is familiar with the commercial XML standard including standard notations, structures, and usage for both DTD files and XML documents.

### CMF Concept

CMF provides fully extensible data types and flexible data structures to meet current and future information exchange requirements. An implementation of the commercial standard Extensible Markup Language (XML) Document Type Definition (DTD) provides the basic data structure for CMF. Although this document consistently references using a DTD, the same data structure information can be maintained/conveyed via an XML Schema Definition (XSD) as well. By retaining DTD compatibility with the XML standard, commercially available tools can be used to create and maintain the DTD.

The DTD contains the implementation framework for the data elements and their tags, attributes, and structure to be found in a CMF data stream. Creating generic parsing software, which contains no hard coded data information, uses the DTD to identify and parse data elements from the data stream is possible.

CMF provides three transmission representation types to support narrowband and wideband mediums. CMF-B is a custom, binary derivation of the XML tag-based standard to be utilized primarily on low bandwidth networks. CMF Efficient (CMF-E) is similar to CMF-B, but provides additional bandwidth saving devices. CMF-X is a “well-formed” and “valid” implementation of the XML commercial standard to be utilized primarily on mid to high bandwidth mediums due to its fully character-based implementation. The CMF-X, being a true XML implementation, supports the use of commercially available tools (e.g., web browsers) for CMF-X parsing, databasing, and display.

CMF thus is a single format with a single set of user definable data elements and attributes, but with three possible ways to represent the data. Since all representations are 100% compatible, transferring data from one representation to the other does not affect data values, units, ranges, or accuracies. The more efficient CMF-B or CMF-E representation should be utilized for high throughput and bandwidth restricted mediums, with full compatibility after transfer to or from CMF-X which supports the use of standard commercial XML tools

Note that neither CMF-B nor CMF-E is limited to only the narrowband mediums, but may also be useful to maximize bandwidth usage on higher bandwidth mediums.

This document is divided into two major sections. Section 1 describes the CMF data structures and construction rules. Section 2 describes the Document Type Definition (DTD) notation conventions and maintenance rules.

To aid in understanding this document, artifacts comprising a hypothetical scenario called “Package Delivery System” are provided. These artifacts include an example DTD and examples of each of the CMF representation types: CMF-X, CMF-B, and CMF-E

### Common Message Format (CMF) DESIGN

The Common Message Format is a data structure that allows flexibility and extensibility in the creation and maintenance of messages and data fields.

CMF-X shall conform to standard XML rules and therefore shall be “well-formed.” CMF-X shall be defined by a DTD, and validated against a DTD, and therefore shall be “a valid document.” By definition, the XML standard, and therefore CMF-X, is totally character based and is thus a human readable data representation. CMF-X shall utilize XML standard tagging and attribute rules. In addition to standard XML rules, there are some limitations on CMF-X provided herein. Any such limitations are in order to maintain translation coherency with CMF-B (and CMF-E) and sustain only permissible data values.

CMF-B is a binary representation derived from the XML tag-based standard. CMF-B is defined by the same DTD, but only conforms to a subset of the standard XML rules and cannot be validated against the DTD using XML standard tools. The CMF-B format is binary and is not readily human readable.

CMF-E is a binary representation conforming to many of the CMF-B constructs with some notable differences to make it more bandwidth efficient. CMF-E is defined by the same DTD, but only conforms to a subset of the standard XML rules and cannot be validated against the DTD using XML standard tools. The CMF-E format is binary and is not readily human readable.

### CMF Tagging

All elements of standard XML are identified by a unique element start tag and a similar end tag. XML elements can also have attributes which further describe the element and/or its content. Basic XML structure includes an element tag before every element. CMF-X follows this construct providing standard character named element tags. CMF-X also provides end tags after the element (and any nested elements) in accordance with standard XML structure.

In contrast, CMF-B provides the start tag for elements but rather than passing it as a string of characters, CMF-B provides the tag as a numeric positive integer value to conserve bandwidth. The tag assignments are made available for each element in the “element_tag” attribute. In CMF-B there are also numerous exceptions to providing a tag for every field. The avoidance of tags is also in order to save bandwidth. CMF-B never provides an end tag because it utilizes self-defining field terminators in combination with group lengths to perform the same function more efficiently.

CMF-E provides a different concept for the start tag for elements. While it still uses a positive integer, CMF-E further conserves bandwidth by limiting the scope of the tag to the current parent, thus reducing the maximum size the integer needs to be. Additionally, the tags are further reduced in size by sending a different integer encoding of a QuadBit (e.g., a 4-bit, or half-byte, based construct that is unique to CMF-E). CMF-E does not use the same integer numbering as CMF-B, and it does not provide a global tag for each element used in all of CMF. It instead provides a Context Sensitive Tag at the GROUP parent level providing the tags for all of that GROUP's children. The tag assignments are made available for each child element in the parent's “e_child_tags” attribute list. The same element might have a different tag when it is included in another parent.

Since a root element does not have a parent element to house its tag for CMF-E, a separate attribute “e_root_tag” is provided. The e_root_tag is defined as part of the root element and only for a root element.

IMPORTANT: In order for CMF-E to function correctly, the e_child_tags and e_root_tag shall never be assigned the value “zero”. The zero has the potential to interfere with the reset capability in certain instances and must be avoided.

### Quadbit Encoding

The QuadBit construct used for all CMF-E tags, and also for some CMF-E elements of e_field_type=QUADBIT_ENUMERATED and e_field_type=QUADBIT_INTEGER, is different from the normal CMF binary construct for most values. By definition, the QuadBit is self-defining for length without requiring a termination bit construct. Also, the QuadBit size is in half-byte increments. It can be a half-byte, a whole byte, one-and-a-half-bytes, two-bytes, etc.

The tag 119 (FFFFFFFEh) is reserved for Processing Instructions and shall NOT be used to define regular CMF-E e_child_tags.

The QuadBit, or half-byte, construct uses an additive concept as opposed to the usual “concatenation of bits” concept when crossing half-byte boundaries. Each half-byte value is “added” to the following half-byte value, if it exists. So, a single half-byte of a QuadBit value can be 0-14 in decimal (0000, 0001, 0010, thru 1110). In order to avoid the use of a normal CMF termination bit, the full “1111” half-byte indicates the value of “15” decimal, but also always indicates another half-byte to follow. Thus, a need to add another half-byte worth of value to the current total for the field. So, for the value=15, two QuadBits (a full byte) will be encoded as “1111 0000” (or 15+0=15).

Similarly, in QuadBit notation, values 16-29 take a full byte encoded as “1111 0001” (15+1=16), “1111 0010” (15+2=17) thru “1111 1110” (15+14=29). After 29, another QuadBit half-byte is added, for a one-and-a-half-byte representation for values 30-44.

While the QuadBit notation provides a smaller representation for small numbers (e.g., values 1-4 fit in half-a-byte instead of the usual full byte), the QuadBit will begin to grow rapidly. So, although it is fully extensible and can accommodate larger numbers, the QuadBit should ONLY be used for integer values when numbers are expected to stay small and not grow. The size savings for the smaller numbers must be weighed against the size growth for the larger numbers.

The following table illustrates how the QUADBIT notation values progress for several values:

TABLE
Quad Bit Notation Values

| 1 QuadBit | 2 QuadBits | 3 QuadBits | 4 QuadBits |
|---|---|---|---|
| (.5 byte) | (1 byte) | (1.5 bytes) | (2 bytes) |
| 0 = 0000 | 15 = 1111 0000 | 30 = 1111 1111 0000 | 45 = 1111 1111 1111 0000 |
| 1 = 0001 | 16 = 1111 0001 | 31 = 1111 1111 0001 | 46 = 1111 1111 1111 0001 |
| 2 = 0010 | 17 = 1111 0010 | 32 = 1111 1111 0010 | 47 = 1111 1111 1111 0010 |
| 3 = 0011 | 18 = 1111 0011 | 33 = 1111 1111 0011 | 48 = 1111 1111 1111 0011 |
| 4 = 0100 | 19 = 1111 0100 | 34 = 1111 1111 0100 | 49 = 1111 1111 1111 0100 |
| 5 = 0101 | 20 = 1111 0101 | 35 = 1111 1111 0101 | 50 = 1111 1111 1111 0101 |
| 6 = 0110 | 21 = 1111 0110 | 36 = 1111 1111 0110 | 51 = 1111 1111 1111 0110 |
| 7 = 0111 | 22 = 1111 0111 | 37 = 1111 1111 0111 | 52 = 1111 1111 1111 0111 |
| 8 = 1000 | 23 = 1111 1000 | 38 = 1111 1111 1000 | 53 = 1111 1111 1111 1000 |
| 9 = 1001 | 24 = 1111 1001 | 39 = 1111 1111 1001 | 54 = 1111 1111 1111 1001 |
| 10 = 1010 | 25 = 1111 1010 | 40 = 1111 1111 1010 | 55 = 1111 1111 1111 1010 |
| 11 = 1011 | 26 = 1111 1011 | 41 = 1111 1111 1011 | 56 = 1111 1111 1111 1011 |
| 12 = 1100 | 27 = 1111 1100 | 42 = 1111 1111 1100 | 57 = 1111 1111 1111 1100 |
| 13 = 1101 | 28 = 1111 1101 | 43 = 1111 1111 1101 | 58 = 1111 1111 1111 1101 |
| 14 = 1110 | 29 = 1111 1110 | 44 = 1111 1111 1110 | 59 = 1111 1111 1111 1110 |

### CMF Data Representations

CMF data values shall be passed using six possible data representations: INTEGER, ENUMERATED, FLOAT, STRING, PATTERN, and PACKED COMPONENT. CMF numerical values shall not contain comma separators. Data values shall be represented in CMF-X, CMF-B, and CMF-E as summarized in the table below and detailed in the following paragraphs.

TABLE
Data Representation Summary

| DATA TYPE | CMF-X | CMF-B/CMF-E |
|---|---|---|
| INTEGER | Passed as a non-decimal number in the | Passed as a binary positive |
| | form of numerical ASCII digit | integer value. Refer to sections |
| | characters only (i.e., each digit in range | below for details. |
| | 0-9 and no negative numbers allowed). | Representation is identical for |
| | Optionally, a unit attribute may be | CMF-B and CMF-E for most |
| | present and an indicator may be present | fields. However, CMF-E offers |
| | to indicate less than or greater than the | an additional |
| | lower or upper range, respectively. | QUADBIT_INTEGER concept to |
| | Refer to sections below for details. | allow bandwidth savings for |
| | | certain INTEGERs when defined. |
| ENUMERATED | Passed as a character string representing | Passed as a binary positive |
| | enumerated string values. Refer to | integer value representing the |
| | sections below for details. | number assigned to the selected |
| | | enumerated string. |
| | | Representation is identical for |
| | | CMF-B and CMF-E, unless an |
| | | e_field_type is set to |
| | | QUADBIT_ENUMERATED. If |
| | | so, in CMF-E, the same value is |
| | | sent using the QUADBIT |
| | | representation. |
| FLOAT | Passed as an ASCII character string | Passed as a combination of CMF |
| | representation of a float value. The float | binary integers and special types |
| | value is expressed in a scientific | of binary integers. The integers |
| | notation form with optional unit | indicate the mantissa and |
| | indicator and accuracy value. Float | exponent of a float value in |
| | values and accuracies may also indicate | scientific notation form along |
| | in an attribute that they represent a | with an optional unit indicator |
| | “less than” or “greater than” value. | and an optional accuracy value in |
| | | scientific notation format. The |
| | | value and accuracy may also be |
| | | indicated to be a “less than” or |
| | | “greater than” value. |
| | | Representation is identical for |
| | | CMF-B and CMF-E. For some |
| | | FLOAT values, the |
| | | “defaults_unit” may be |
| | | overridden by an “e_default_unit” |
| | | for CMF-E. |
| STRING | Passed as a standard XML string of | Passed as a series of 7-bit ASCII |
| | characters. | characters which are self-defining |
| | | for length. |
| | | Representation is identical for |
| | | CMF-B and CMF-E for most |
| | | fields. However, CMF-E |
| | | provides an additional |
| | | ENUMERABLE_STRING |
| | | concept for bandwidth savings for |
| | | certain strings that have pre- |
| | | defined values. |
| PATTERN | Passed as the character representation | Passed as one or more series of 7- |
| | of all components of the pattern. | bit ASCII characters which are |
| | | self-defining for length and/or as |
| | | one or more binary positive |
| | | integer values. |
| | | Representation is identical for |
| | | CMF-B and CMF-E. |
| PACKED | Passed as the character representation | Passed with other PACKED |
| COMPONENT | of the current state of a two-state value | COMPONENTs in one or more |
| | (e.g., “On”, “Off”, “Enabled”, | PACKED element bytes. |
| | “Disabled”, etc.). | PACKED COMPONENTs use |
| | | two-bits each to indicate one of |
| | | four possible states. The four |
| | | possible states are the two value |
| | | states plus the no-change/default |
| | | and reset states. |
| | | Representation is identical for |
| | | CMF-B and CMF-E. |

### CMF-X Data Representations

CMF-X data representations have the following characteristics:
a. Values are fully extensible
b. The length of all values is determined using end tags
c. Many values have a “Reset” attribute to indicate a “Reset to No Data or Initial Value”. “Reset to No Data or Initial Value” tells the recipient that any values previously sent for the particular field should be reset to the initial value or to the “No Data” state meaning (i.e., just as though data was never sent for the respective value).
d. All CMF-X FIELD type data elements being transmitted shall have values unless reset.

The data representations used by CMF-X are as follows:
a. Positive INTEGER
b. ENUMERATED
c. FLOATing Point/Signed Integer
d. STRING
e. PATTERN
f. PACKED COMPONENT
g.

All data representations in CMF-X shall be passed as character strings.

### CMF-X Positive Integer Data Representation

In CMF-X, the Positive INTEGER data representation shall be passed as numerical ASCII digit characters only (i.e., each digit in range 0-9 and no negative numbers allowed). Comma separators shall not be supported in the input or output values.

An INTEGER element may also indicate something “less than” the defined lower range of the element or something “greater than” the defined upper range of the element by inclusion of a value qualifier attribute in the CMF-X. If a “less than” qualifier is defined, the defined lower range shall not be 0. Additionally, a unit indicator attribute may be defined and, if defined, shall be present in CMF-X.

CMF-X may likewise contain “value offset” or “value multiplier” indicator attributes defined as constant values to which the reported INTEGER value shall be added or multiplied by, respectively, to obtain the actual reported value. In the case where both “value offset” and “value multiplier” attributes are provided, the precedence for transmit is “value multiplier” then “value offset” and the reverse is true for the receiver.

### CMF-X Enumerated Data Representation

The ENUMERATED data representation provides a way to pass a value selected from an enumerated (i.e., finite individually numbered), pre-defined list of character strings. In CMF-X, the value for an ENUMERATED data representation shall be passed using the selected character string exactly as declared and enclosed in its character-based start and end tags.

### CMF-X Floating Point/Signed Integer Data Representation

The basis of the FLOATing Point/Signed Integer data representation shall be either decimal notation or scientific notation. Scientific notation shall be expressed as follows: if “x” is the mantissa and “y” is the exponent, then the value is equal to ±x*10±Y which is more commonly expressed as “±xE±y”. Note either of the leading signs may be left off if they are positive. In CMF-X, the FLOATing Point/Signed Integer data representation shall be passed in scientific notation in the form of:
“(s1m1Es2e1)”
where s1 is the sign of the mantissa for float value,
m1 is the mantissa of the float value,
E is the letter “E” or “e” indicating a power of ten,
s2 is the sign of the exponent of the value, and
e1 is the exponent of the value.

The transmitted form of a CMF-X float string is determined by the encoding parser. Both the scientific notation and decimal forms shall be accepted by the decoding parser. Comma separators shall not be supported in the input or output values and CMF floating point representations shall not support values for infinity (INF), negative infinity (−INF), or not-a-number (NAN). An example CMF-X float string is: “−10E-1” indicating a value of minus 1.0. Alternatively, the CMF-X float value may be represented with a decimal point such as 124.75 or even as 1.2475E2.

In addition to the value itself, the float representation in CMF-X may have units or accuracy assigned or selectable. The unit value, if declared in the DTD, shall be provided in the CMF-X stream as the selected unit character string in a unit attribute of the floating point element using standard XML attribute notation. Likewise, if the accuracy attribute is declared in the DTD and an accuracy value (other than one equal to the implied accuracy of the float's value) is provided by the host, it shall be provided as an accuracy attribute of the floating point element in the form:
“(s3m2Es4e2)”
where s3 is the sign of the mantissa for the value's accuracy,
m2 is the mantissa of the value's accuracy,
E is the letter “E” or “e” indicating a power of ten,
s4 is the sign of the exponent for the accuracy, and
e2 is the exponent of the accuracy.

Note here, the “s3” leading sign may be left off if it is positive or may always be left off since the accuracy is interpreted to always be a plus or minus value. Additionally, attributes are available for float elements to indicate that the float value and/or the accuracy provided is a reported value that is actually either a “less than” or “greater than” value. In other words, the true value is known by the data originator to be something less than or greater than the value which was reported. If either the accuracy upper or the lower range attributes are declared (or both), the associated accuracy attribute value shall inclusively fall within the range defined by the accuracy attribute values. This applies to either assigned accuracy values or implied accuracy values.

### CMF-X String Data Representation

In CMF-X, the value for the STRING data representations shall be passed as a standard XML string of characters enclosed in its character-based start and end tags. Character values for a string shall be limited to 7-bit ASCII.

### CMF-X Pattern Data Representation

The PATTERN representation provides the ability to mix numeric and alphabetic data in a single element to represent fields having predetermined and typically complex patterns. Such mixes of data are possible with the CMF string representation, but the PATTERN representation provides control over the contents of the value and, for CMF-B, additional bandwidth efficiency not otherwise available.

In CMF-X the PATTERN representation shall be passed as the character representation of all components of the pattern where all components meet the pattern specification.

The pattern is defined in the DTD in the form:
“charcount<fieldIDs>charcount<fieldIDs> . . . charcount<fieldIDs>”
where each “charcount<fieldIDs>” is one component of the pattern,
“charcount” identifies how many characters are to be provided for the pattern component, and
“<fieldIDs>defines the pattern for the component using a combination of special field IDs or standard field IDs.

The number of “fieldIDs” can be greater than the “charcount” in that any combination of the provided “fieldIDs” is allowed as a value for the component, but the transmitted combination shall be no more and no less than “charcount” characters.

For CMF-X, all components shall be sent as a standard XML string of characters. The total number of characters sent shall be the sum of all the “charcount” values (except those within exclusivity enclosures).

TABLE
PATTERN Field IDs

| Special Field IDs | | Standard Field IDs | |
|---|---|---|---|
| N = | Numeric digit (integer value 0-9) | ? = | Question mark character |
| A = | Alphabetic character (A-Z or a-z only) | @ = | At sign character |
| D = | Digit character (character 0-9) | ~ = | Tilde character |
| X = | Alphanumeric character (A-Z, a-z, or 0-9) | ! = | Exclamation character |
| Y = | Any printable 7-bit ASCII character | # = | Pound character |
| Z = | Any 7-bit ASCII character (CMF codes only) | $ = | Dollar character |
| S = | Space character | \hat{ } = | Carat character |
| H = | Hyphen character | \| = | Vertical Bar character |
| U = | Underscore character | { = | Left Brace character |
| P = | Period character | } = | Right Brace character |
| C = | Comma character | * = | Asterisk character |
| Q = | Forward Quote (single quote) character | + = | Plus sign character |
| B = | Backward Quote (single quote) character | / = | Forward slash character |
| M = | Marks (double quote) character | \ = | Backward slash character |
| E = | Equals sign character | : = | Colon character |
| L = | Left parenthesis character | ; = | Semi-colon character |
| R = | Right parenthesis character | | |
| O = | Originate (left) Bracket | | |
| T = | Terminate (right) Bracket | | |
| F = | Fewer than character | | |
| G = | Greater than character | | |
| J = | Join (Ampersand) character | | |
| V = | Variance (Percent) character | | |

TABLE
PATTERN Field IDs

N(m-n) = Allowable range for digits of numeric integer where “m” defines the lower
numeric value range and “n” identifies the upper numeric value range. Both range values
are always positive. For example (32-74).
A(A-Z)(a-z) = Allowable range of alpha characters where “A” identifies the lowest
allowable uppercase alpha character, “Z” identifies the highest allowable uppercase alpha
character, “a” identifies the lowest allowable lowercase alpha character, and “z” identifies
the highest allowable lowercase alpha character. Note lack of the entire uppercase or
lowercase range disallows the characters of uppercase or lowercase, respectively. For
example A(M-R) or A(m-r) or A(M-R)(m-r) are legal. The ranges may appear in either
order and more than one of each type may occur to obtain discontinuous ranges. For
example, A(m-r)(M-R) and A(M-R)(Y-Z) are also legal.
D(m-n) = Allowable range of character digits where “m″ defines the lower character digit
and “n” identifies the upper character digit. Both digits are always positive. For example
(2-7).
X(A-Z)(a-z)(0-9) = Allowable range of alphanumeric characters where “A” identifies the
lowest allowable uppercase alpha character, “Z” identifies the highest allowable uppercase
alpha character, “a” identifies the lowest allowable lowercase alpha character, “z”
identifies the highest allowable lowercase alpha character, “0” identifies the lowest
allowable character digit, and “9” identifies the highest allowable character digit. Note
lack of the entire uppercase or lowercase range disallows the characters of uppercase or
lowercase, respectively. For example X(M-R)(4-7) or X(m-r)(3-7) or X(M-R)(m-r)(3-7)
are legal. The ranges may appear in any order and more than one of each type may occur
to obtain discontinuous ranges. For example, X(m-r)(M-R)(3-7), X(M-R)(Y-Z)(3-7), and
X(3-7)(m-r)(M-R) are also legal.
[charcount<fieldIDs>charcount<fieldIDs> . . . charcount<fieldIDs>] = This set of IDs is
exclusive with other IDs within the enclosing component.

As a very simple example, the pattern “1A” represents an element whose value can contain a single letter in the uppercase range “A” through “Z” or the lowercase range “a” through “z”. Similarly the pattern “2A(m-o)” would allow for two characters but both can only be in the lowercase range of “m” through “o”. The pattern 1ASH1D1N shows that the first character can be an uppercase or lowercase A-Z, can be a space, or can be a hyphen. The second character must be a single character digit in the range 0-9, and the final character must be an integer in the range 0-9 which for CMF-X will be passed as a character

For CMF-X, the DTD pattern “1DE2[2N(0-42)][2N(50-50)]” would define a field where:
a. The first component group is character and contains either the character digits 0-9 or the equals sign character.
b. The second component group, although defined as numeric (i.e., INTEGER), is character because this is the XML version of CMF and it contains a character value in the range zero to forty-two or contains the value fifty.
c. Both component groups are sent as one single three-character string as the value for the PATTERN element.
d. The number directly preceding the bracketed definitions (i.e., the charcount) provides the total number of characters that must be defined within each of the brackets. Thus in the example above, the exclusive patterns within the brackets each define 2 characters of data.

Example legal field representations would be:

$$942 or 550 or = 00 or = 09$$

Given a DTD pattern of “5[3A(A-G)2N(0-77)][3A(H-M)2N(78-99)]” some of the valid representations would include:
ABC76 or HIM99 or AAA00 or MMM78 (note that HHH22 would be illegal).

Given a DTD pattern of “1D4[3A(a-z)1N(1-5)][3A1N(8-9)]” some of the valid representations would include:
9abc4 or 1FFF8 or 9ZZZ9 or 5ABz9 (note that laaB4 would be illegal).

For a DTD pattern of “1X2[1A(a-z)1X(L-M)(1-5)][1A1A]” some of the valid representations would include:
9aL or Rbb or mz5 or 1AA (note that RA5 would be illegal).

### CMF-X Packed Component Data Representation

The PACKED COMPONENT representation provides a way to represent single binary bit valued data (i.e., boolean) such as fields that are on/off, true/false, enabled/disabled, etc. Each PACKED COMPONENT is declared with a character string representing one or both of the “set” and “not set” states.

In CMF-X, each PACKED COMPONENT shall be treated as a separate element and transmitted as the appropriate character string to represent the current value (i.e., the characters indicating the “set” value or the characters indicating the “not set” value) along with the named character tags for each PACKED COMPONENT. The character representations for each of the two states shall be provided in the DTD declaration via an attribute.

### CMF-B Data Representations

CMF-B data representations have the following characteristics:
a. Values are fully extensible
b. All values are self-defining for field length using a termination bit
c. All values having a “Reset” attribute use the instance of all bits in a byte set to zero to indicate a “Reset to No Data or Initial Value”. “Reset to No Data or Initial Value” tells the recipient that any values previously sent for the particular field should be reset to the initial value or to the “No Data” state meaning (i.e., just as though data was never sent for the respective field).
d. Notwithstanding the actual CMF-B encoding scheme, all CMF-B FIELD type data elements being transmitted shall have values unless reset.

The data representations used by CMF-B are as follows:
a. Positive INTEGER
b. ENUMERATED
c. FLOATing Point/Signed Integer
d. STRING
e. PATTERN
f. PACKED COMPONENT

All data representations are byte oriented meaning all bits of each byte belong to one and only one data value (with the exception of the PACKED element type) and CMF-E constructs. The CMF documentation is based upon a big-endian orientation and all bytes shall be constructed as follows (prior to any transmission medium adjustment). All CMF-B data representations use the seven least significant bits, bits 0-6, of each byte to represent data. Bit 7, the most significant bit (MSB) and leftmost in the big-endian the field extends/continues to the next byte. Bits 0-6 in any extension bytes orientation, is used as a termination flag. As long as bit seven of a byte is zero (with the exception of the reset value where all bits of the byte are zero), become the new least significant bits and the 0-6 bits from all bytes are concatenated together to form the full value for the field. When bit seven of a byte is set to one, that byte is the last byte of the field, and the following byte is part of the next element or value (exceptions are the FLOAT and PATTERN elements which require multiple values each in this byte extension manner to provide the complete element).

### CMF-B Positive Integer Data Representation

For CMF-B, the Positive INTEGER data representation shall use the least significant seven bits, 0-6, of each byte as data (bit 7 is the termination bit). The first byte shall represent the most significant 7 bits of the integer, with each successive byte representing lesser significant 7 bits, until the last byte, which represents the least significant 7 bits of the integer. Leading zeros can be placed on the original values, but they shall not be preserved through CMF-B transmission. Comma separators shall not be supported in the input or output values.

CMF-B Example: The integer “255”, (FFh) uses two bytes as follows in hexadecimal: “01-FF” or in binary (dash only for clarity): “0-0000001 1-1111111”. Note the termination bit set in the last byte.

CMF-B Example 2: The integer value “11,212,230”, (AB15C6h) uses four bytes in CMF-B as follows in hexadecimal: “05-2C-2B-C6” or in binary 0-0000101 0-0101100 0-0101011 1-1000110. Note the termination bit set in the last byte.

### CMF-B Positive Integer Less/Greater Indication

If a value qualifier attribute is defined for an INTEGER element, in CMF-B the element may also indicate something “less than” the defined lower range of the element or something “greater than” the defined upper range of the element by the actual transmission of a value which shall be one less than the lower range or one greater than the upper range, respectively.

### CMF-B Enumerated Data Representation

The ENUMERATED data representation provides a way to pass a value selected from an enumerated (i.e., finite individually numbered), pre-defined list of character strings. For enumerated data, both a character enumeration string and an equivalent integer number shall be declared in the DTD for each allowable value. In CMF-B only the equivalent integer values shall be passed.

CMF-B Example: The enumeration string “Japan” assigned an equivalent integer of “57”, (39h) uses one byte as follows in hexadecimal: “B9” or in binary 1-0111001. Note the termination bit set in the byte.

### CMF-B Float Signed Integer Data Representation

The FLOATing Point/Signed Integer data representation is scientific notation and shall be constructed as described in the following sections. The basic structure of scientific notation is as follows: if “x” is the mantissa and “y” is the exponent, then the value is equal to ±x*10±y. The mantissa part x is represented by a positive integer and is followed by one or more extension bytes. Leading zeros can be placed on the original values, but they shall not be preserved through CMF-B transmission. Comma separators shall not be supported in the input or output values.

The mantissa bit pattern (same as a positive integer) is:
Tbbbbbbb where T is byte terminator bit (if T=0, more mantissa bytes follow) and b is bits of the mantissa value

The first extension byte has the normal CMF-B terminator bit in the MSB (i.e., bit 7), the sign bit for the mantissa in bit 6 (0=positive, and 1=negative), the sign bit for the exponent in bit 5 (0=positive, and 1=negative), and 5-bits of exponent in bits 0-4. If additional exponent range is required, or units other than the default are defined and are being provided, an accuracy other than the default is defined and is being provided, and/or the value and/or the accuracy is to indicate a “less than” or “greater than” value, then at least one additional extension byte follows the first extension byte.

1st Extension bit pattern is:
Ts1s2eeeee where T is byte terminator bit (if T=0, 2nd Extension byte follows),
s1 is sign of mantissa,
s2 is sign of exponent, and
e is bits of the exponent value

The second extension byte has the normal CMF-B terminator in the most significant bit (MSB) (i.e., bit 7), a bit indicating whether selectable units is being provided in bit 6 (bit=1 indicates “present”, 0 or lack of this byte represents “not present”), a bit indicating whether a selectable accuracy value is being sent in bit 5 (bit=1 indicates “present”, 0 or lack of this byte represents “not present”), and an additional 5-bits of exponent in bits 0-4. If this is the final byte of the exponent extension (MSB=1), then the additional 5-bits of exponent contain the least significant bit (LSB) bits of the exponent and are used in combination with the 5-bits in the first extension byte. Otherwise the exponent LSB bits are in a later extension byte and this byte has 5-bits of middle significance.

2nd Extension bit pattern is:
Tuaeeeee where T is byte terminator bit (if T=0, 3rd Extension byte follows),
u is selectable units indicator,
a is selectable accuracy indicator, and
e is additional bits of the exponent value

If the second extension byte is present and presence of selectable units is indicated by the selectable units indicator bit (bit 6=1), then the final extension byte will be followed by a positive integer containing the equivalent integer for the units enumeration declared in the DTD.

Likewise, if the second extension byte is present and the presence of selectable accuracy is indicated by the selectable accuracy bit (bit 5=1), then the final extension byte (or final selectable unit byte, if present) will be followed by a positive integer containing the mantissa of the selectable accuracy. The final byte of any selectable accuracy mantissa integer is followed by another extension byte of the first type and if necessary, extension bytes of the fifth type to provide the selectable accuracy signs and exponent.

The third extension byte has the normal CMF-B terminator in the MSB (i.e., bit 7), a bit indicating whether the reported float value represents a true value which is actually something less in bit 6 (bit=1 indicates “less than”, 0 here and in bit 5 or lack of this byte represents “actual float value reported”), a bit indicating whether the reported float value represents a true value which is actually something greater in bit 5 (bit=1 indicates “greater than”, 0 here and in bit 6 or lack of this byte represents “actual float value reported”), and an additional 5-bits of exponent in bits 0-4. If this is the final byte of the exponent extension (MSB=1), then the additional 5-bits of exponent contain the LSB bits of the exponent and are used in combination with the 5-bits in the first and second extension bytes. Otherwise, the exponent LSB bits are in a later extension byte and this byte has 5-bits of middle significance.

3rd Extension bit pattern is:
Tlgeeeee where T is byte terminator bit (if T=0, 4th Extension byte follows),
l is a “less than” indicator,
g is a “greater than” indicator, and
e is additional bits of the exponent value

Note that the “less than” (l) and “greater than” (g) bits in bits 6 and 5, respectively are mutually exclusive meaning they cannot both be set at the same time in the third extension byte.

The fourth extension byte has the normal CMF-B terminator in the MSB (i.e., bit 7), a bit indicating whether the reported accuracy value represents a true value which is actually something less in bit 6 (bit=1 indicates “less than”, 0 here and in bit 5 or lack of this byte represents “actual accuracy value reported”), a bit indicating whether the reported accuracy value represents a true value which is actually something greater in bit 5 (bit=1 indicates “greater than”, 0 here and in bit 6 or lack of this byte represents “actual accuracy value reported”), and an additional 5-bits of exponent in bits 0-4. If this is the final byte of the exponent extension (MSB=1), then the additional 5-bits of exponent contain the LSB bits of the exponent and are used in combination with the 5-bits in the first and second extension bytes. Otherwise, the exponent LSB bits are in a later extension byte and this byte has 5-bits of middle significance.

4th Extension bit pattern is:
Tlgeeeee where T is byte terminator bit (if T=0, 5th Extension byte follows),
l is a “less than” indicator,
g is a “greater than” indicator, and
e is additional bits of the exponent value

Note that the “less than” (l) and “greater than” (g) bits in bits 6 and 5, respectively are mutually exclusive meaning they cannot both be set at the same time in the third extension byte.

If a fifth or greater extension byte is required for either the float value exponent or selectable accuracy exponent, bits 5 and 6 are undefined in those bytes, and must be set to zero.

5th Extension bit pattern is:
T00eeeee where T is byte terminator bit (if T=0 more of this byte follow),
00 are two undefined bits-both set equal to zero, and
e is bits of the exponent value

### Units

Each element may or may not have a defined default unit assigned in the DTD via one of the default unit keyword attributes. If assigned, the binary data parser shall pass a data value, not matching a defined default value, without sending a unit indicator if the value is to be represented in the default units. Some floating point elements also may or may not have an available unit selector attribute. If the unit equivalents attribute for the element is provided in the DTD and a producer sends data in units other than the assigned default, the parser shall set the selectable units indicator and provide a unit's positive integer value immediately following the final extension byte.

### Accuracy

Floating point types can inherently imply their measured accuracy in the mantissa given the producer provides the data in the same base unit as their accuracy and their accuracy is an exact power of ten (i.e., 100, 10, 1, 0.1, 0.01, 0.001, etc.). For example, data measured as 25.67 Hz plus or minus 0.001 Hz can be indicated by the host providing the data value to CMF as 25.670 which would be represented in the CMF-B floating point form as “25670E-3”. CMF accuracy is a plus or minus error value with reference to the estimated/actual value rather than a precision or resolution. Only when an accuracy value has not been provided by the producer but an accuracy attribute is defined for the element, does CMF utilize the precision represented by the element value to assume the implied accuracy. Additionally, when the producer provides an accuracy which matches the assigned default value, the accuracy value shall not be encoded in CMF-B by the parser.

For many floating point elements, an accuracy selector is provided to indicate the correct producer's accuracy when the units are not the same or the producer's accuracy is not an exact power of ten (i.e., 25, 0.003, 3.9, etc.). If the accuracy selector is provided in the DTD, and the producer provides an accuracy other than the assigned default, then the selectable accuracy indicator shall be set by the parser and an accuracy value immediately following the units byte or if the units is not present, immediately following the final extension byte.

CMF-B Example 1: Value “12.7” (127*10-1) with units (value 1=Hertz) and accuracy of tenths (1*10-1) uses six bytes as follows in binary (dashes only for clarity): “1-1111111 0-0-1-00000 1-1-1-00001 1-0000001 1-0000001 1-0-1-00001”. Note the termination bits set in both bytes.

NOTE: The first byte is the value's mantissa. The second is an extension byte of type one including the value's signs and first portion of the exponent (MSB bits of all zeros). The third byte is an extension byte of type two including the units/accuracy indicators and the LSB bits of the value's exponent. The fourth byte is units indicator (1=Hz). The fifth byte is the mantissa of the accuracy and the sixth byte is a type one extension byte containing the accuracy signs and exponent.

CMF-B Example 2: Negative signed integer “−47”, (D1h) uses two bytes as follows in hexadecimal: “AF-C0”. Note the termination bits set in both bytes.

CMF-B Example 3: Value “12.7” (127*10-1) uses two bytes as follows in hexadecimal: “FF-A1” or in binary (dashes only for clarity): “1-1111111 1-0-1-00001”. Note the termination bits set in both bytes.

CMF-B Example 4: Value 127*1036 uses three bytes as follows in hexadecimal: “FF-01-84”. Note the termination bits set in the first and last bytes.

CMF-B Example 5: Value 0.000000000000000000000000000000000127 (127*10-36) uses three bytes as follows in hexadecimal: “FF-21-84”. Note the termination bits set in the first and last bytes.

CMF-B Example 6: Value “127.95” (12795*10-2) uses three bytes as follows in hexadecimal: “63-FB-A2”. Note the termination bits set in the second and last bytes.

CMF-B Example 7: Value “−127.95” (−12795*10-2) uses three bytes as follows in hexadecimal: “63-FB-E2”. Note the termination bits set in the second and last bytes.

CMF-B Example 8: Value “−127.95” (−12795*10-2) with non-default unit value of 3 uses five bytes as follows in hexadecimal: “63-FB-60-C2-83” or in binary: “0-1100011 1-1111011 0-1-1-00000 1-1-0-00010 1-0000011”.

Note the termination bits set in the second, fourth, and last bytes. The first and second bytes contain mantissa value of 12795. The third byte contains negative signs for mantissa and exponent. The fourth byte contains unit present indicator and exponent value of 2. The final byte contains unit value of 3.

CMF-B Example 9: Value “127.95” (12795*10-2) with non-default unit value of 4 and non-default accuracy of >±0.05 uses nine bytes as follows in hexadecimal: “63-FB-20-60-00-A2-84-85-A2” or in binary:
“0-1100011 1-1111011 0-0-1-00000 0-1-1-00000 0-0-0-00000 1-0-1-00010 1-0000100 1-0000101 1-0-1-00010”.

Note the termination bits set in the second and sixth through last bytes. The first and second bytes contain element mantissa value of 12795. The third byte contains negative sign for element exponent. The fourth byte contains unit present and accuracy present indicators. The fifth byte is empty but must be present in order to provide the following type 4 extension byte. The sixth byte contains “greater than” indicator for accuracy and exponent value of 2. The seventh byte contains unit value of 4. The eighth byte contains accuracy mantissa of 5 and the ninth contains negative sign for accuracy exponent and accuracy exponent value of 2.

CMF-B Example 10: Value indicating “>127.95” (>12795*10-2) with non-default unit value of 4 uses six bytes as follows in hexadecimal: “63-FB-20-40-A2-84” or in binary: “0-1100011 1-1111011 0-0-1-00000 0-1-0-00000 1-0-1-00010 1-0000100”.

Note the termination bits set in the second, fourth, and last bytes. The first and second bytes contain mantissa value of 12795. The third byte contains negative sign for exponent. The fourth byte contains unit present indicator. The fifth byte contains “greater than” indicator and exponent value of 2. The final byte contains unit value of 4.

### CMF-B String Data Representation

In CMF-B, the STRING data representation shall use the 7-bit American Standard Code for Information Interchange (ASCII) values 0-127 (0h-7Fh). See Table below ASCII Table (Termination Bit Clear) for character encoding. The STRING type shall not use the ASCII extended codes, values 127-255 (80h-FFh) because in CMF-B the MSB (i.e., bit 7 or 8th bit) is reserved for the termination indicator bit. The 7-bit ASCII code uses bits 0-6 of each byte to represent a character from the ASCII character set. Also note that the STRING type shall not use the non-printable 7-bit ASCII codes, values 0-31 (00h-1Fh) and value 127 (7Fh) except for the horizontal tab (HT) value 9 (09h), line feed (LF) value 10 (0Ah), and carriage return (CR) value 13 (0Dh). As is the case for all CMF-B data representations bit 7, the most significant bit, shall be used as a termination flag. With the exception of the reset case, as long as bit seven of a byte in a string field is clear (0), the string field shall extend to the next byte (i.e., there is another character as part of the representation). When bit seven is set (1), the character in that byte shall be the last character of the field value and any following byte shall be part of the next element or value. The tables below show ASCII codes with the termination bit cleared or set.

TABLE
ASCII Table (Termination Bit Clear)

| | 0 | 1 | 2 | 3 | 4 | 5 | 6 | 7 | 8 | 9 | A | B | C | D | E | F |
|---|---|---|---|---|---|---|---|---|---|---|---|---|---|---|---|---|
| 0 | [symbol] | [symbol] | [symbol] | [symbol] | [symbol] | [symbol] | [symbol] | [symbol] | [symbol] | HT | LF | [symbol] | [symbol] | CR | [symbol] | [symbol] |
| 1 | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| 2 | SP | ! | ″ | # | $ | % | & | ′ | ( | ) | * | + | , | - | . | / |
| 3 | 0 | 1 | 2 | 3 | 4 | 5 | 6 | 7 | 8 | 9 | : | ; | < | = | > | ? |
| 4 | @ | A | B | C | D | E | F | G | H | I | J | K | L | M | N | O |
| 5 | P | Q | R | S | T | U | V | W | X | W | Z | [ | \ | ] | \hat{ } | _ |
| 6 | ‘ | a | b | c | d | e | f | g | h | i | j | k | l | m | n | o |
| 7 | p | q | r | s | t | u | v | w | x | y | z | { | \| | } | ~ | [symbol] |

TABLE
ASCII Table (Termination Bit Set)

| | 0 | 1 | 2 | 3 | 4 | 5 | 6 | 7 | 8 | 9 | A | B | C | D | E | F |
|---|---|---|---|---|---|---|---|---|---|---|---|---|---|---|---|---|
| 8 | [symbol] | [symbol] | [symbol] | [symbol] | [symbol] | [symbol] | [symbol] | [symbol] | [symbol] | HT | LF | [symbol] | [symbol] | CR | [symbol] | [symbol] |
| 9 | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| A | SP | ! | ″ | # | $ | % | & | ′ | ( | ) | * | + | , | - | . | / |
| B | 0 | 1 | 2 | 3 | 4 | 5 | 6 | 7 | 8 | 9 | : | ; | < | = | > | ? |
| C | @ | A | B | C | D | E | F | G | H | I | J | K | L | M | N | O |
| D | P | Q | R | S | T | U | V | W | X | W | Z | [ | \ | ] | \hat{ } | _ |
| E | ‘ | a | b | c | d | e | f | g | h | i | j | k | l | m | n | o |
| F | p | q | r | s | t | u | v | w | x | y | z | { | \| | } | ~ | [symbol] |

CMF-B Example 1: The one word element value, “CMF”, contains three bytes as follows in binary (the dash is only for clarity): “0-1000011 0-1001101 1-1000110”. Note the termination bit set in the last byte.

CMF-B Example 2: The one word element value, “TEST”, contains four bytes as follows in hexadecimal: “54-45-53-D4” (0-1010100 0-1000101 0-1010011 1-1010100). Note the termination bit set in the last byte.

CMF-B Example 3: The multiple word element value, “This is a test”, contains 14 bytes as follows in hexadecimal: “54-68-69-73-20-69-73-20-61-20-74-65-73-F4” (0-1010100 0-1101000 0-1101001 0-1110011 0-0100000 0-1101001 0-1110011 0-0100000 0-1100001 0-0100000 0-1110100 0-1100101 0-1110100 0-1100101 0-1110011 1-1110100). Note the termination bit set in the last byte.

### CMF-B Pattern Data Representation

The PATTERN representation provides the ability to mix numeric and alphabetic data in a single element to represent values having predetermined and typically complex patterns. Such mixes of data are possible with the CMF string representation, but the PATTERN representation provides control over the contents of the value and, for CMF-B, additional bandwidth efficiency not otherwise available.

In CMF-B the PATTERN representation shall be passed as one or more series of 7-bit ASCII characters which are self-defining for length and/or as one or more binary positive integer values. The determination of how many characters versus how many positive integers, and in what order, shall be determined from the pattern representation.

For CMF-B, all components using one of the character type representations (with the exception of the “N” and “N(m-n)” fieldID types) shall be sent as a string of characters using the basic CMF STRING data representation. The length of each of these components shall be equal to the “charcount” value for the component. All components having a “fieldtype” of “N” (and the field limited “N(m-n)”) shall be sent as integer values using the basic CMF positive INTEGER data representation.

For CMF-B, the pattern “1DE2[2N(0-42)][2N(50-50)]” would define a field where:
a) the first component group is character and contains either the character digits 0-9 or the equals sign character, (component sent in CMF-B as one character byte)
b) the second component group is INTEGER and contains a value in the range zero to forty-two or contains the value fifty. (component sent in CMF-B as one INTEGER byte).

Example legal field representations would be: 942 or 550 or =0 or =9

For 942 the CMF-B representation would contain two bytes as follows in hexadecimal: “B9-AA” or in binary: “1-0111001 1-0101010”. Note the termination bit set in both bytes.

### CMF-B Packed Component Data Representation

The PACKED COMPONENT representation provides a way to represent single binary bit valued (i.e., Boolean) data such as fields that are on/off, true/false, enabled/disabled, etc. Each PACKED COMPONENT is declared with a character string representing each of the “set” and “not set” states.

For CMF-B, PACKED COMPONENTs shall use two bits each to indicate one of four possible states. The first PACKED COMPONENT uses bits 4-5, second uses 2-3, and third uses 0-1. The four possible states shall be the two-value (i.e., Boolean) definable states with bit settings of 01 and 10 (i.e., values 1 and 2) plus the reset and no-change states which shall be reserved for the bit settings of 00 and 11 (i.e., values 0 and 3), respectively. Note that the reserved bit setting for the reset condition shall not be a legal value unless the reset attribute is declared for the specific PACKED COMPONENT element.

In CMF-B, the PACKED COMPONENT data representation shall be sent within a PACKED element. In the PACKED element, up to 3 PACKED COMPONENTS shall be represented in each byte of a packed data field using bits 0-5. As in other CMF-B data representations, the MSB bit 7 shall be used as a terminator byte. As long as bit 7 of a byte in a PACKED element is clear (i.e., zero), the PACKED element shall extend to the next byte (i.e., there are up to 3 more two-bit data values as part of the representation for each additional byte). When bit 7 is set to one, any following byte shall be part of the next element or value.

### CMF-E Data Representations

CMF-E data representations are in most cases completely the same as CMF-B representations and have the following characteristics:
a. Values are fully extensible.
b. Most values are self-defining for field length using a termination bit, identical to CMF-B. CMF-E has an additional QuadBit construct (used for e_child_tags, some ENUMERATED values, and some INTEGERs) that is encoded differently and without the need for a termination bit.
c. Resets function identically to CMF-B

The data representations shared by CMF-B and CMF-E are as follows:
a. Positive INTEGER—identical to CMF-B, except for certain fields where QUADBIT_INTEGER encoding is utilized for CMF-E
b. ENUMERATED—identical to CMF-B, except for certain fields where QUADBIT_ENUMERATED encoding is utilized for CMF-E
c. FLOATing Point/Signed Integer—identical to CMF-B (with possible difference for default unit in CMF-E)
d. STRING—identical to CMF-B, except for certain fields/values where ENUMERABLE_STRING encoding is utilized for CMF-E (primarily for mnemonics encoding)
e. PATTERN—identical to CMF-B
f. PACKED COMPONENT—identical to CMF-B

Data representations in CMF-E match CMF-B for all element_types, unless a specific e_field_type exists to override the field_type. The alternate/overriding CMF-E e_field_type constructs include QUADBIT_ENUMERATED and QUADBIT_INTEGER. Additionally, the e_field_type ENUMERABLE_STRING, allows flexibility between a regular STRING and an enumeration to be utilized. These types are to be used only on fields where bandwidth savings can be realized using the alternate representation. Thus, some fields have the overriding e_field_type and others do not. If an e_field_type is not specifically assigned to a particular field in the DTD, then the data representation will utilize representation called out in the field_type attribute, and utilize the same encoding as CMF-B.

### CMF-E Positive Integer Data Representation

For elements defined as field_type INTEGER, without an additional e_field_type definition QUADBIT_INTEGER, the integer representation for CMF-E is identical to CMF-B.

For elements defined as field_type INTEGER and also as e_field_type QUADBIT_INTEGER, the integer representation for CMF-E will utilize the QuadBit encoding. Additionally, in order to avoid any potential “zero” conflicts with the reset construct, all values will be offset by “one”. In other words, when encoded in CMF-E, all QUADBIT_INTEGER values will be incremented by one. When decoded, all QUADBIT_INTEGER values will be decremented by one (returned to its original value), prior to presentation to the host application. This offset functionality (add/subtract one) will be transparent to the host application and performed completely within the parser library.

### CMF-E Positive Integer Less/Greater Indication

The value_qualifier attribute works the same way for CMF-E as it does for CMF-B.

### CMF-E Enumerated Data Representation

For elements defined as field_type ENUMERATED, data representation for CMF-E is identical to that of CMF-B when no additional e_field_type is defined.

However, for elements defined as field_type-ENUMERATED and also as e_field_type=QUADBIT_ENUMERATED, the integer enumeration values (as provided by the attribute defined_values) are sent in CMF-E in the QuadBit encoded form. Additionally, in order to avoid any potential “zero” conflicts with the reset construct, all values will be offset by “one”. In other words, when encoded in CMF-E, all QUADBIT_ENUMERATED values will be incremented by one before insertion in the data stream. When decoded, all QUADBIT_ENUMERATED values will be decremented by one (returned to its original value), prior to presentation to the host application. This offset functionality (add/subtract one) will be transparent to the host application and performed completely within the parser library.

### CMF-E Float Signed Integer Data Representation

The FLOATing Point/Signed Integer data representation for CMF-E is identical to that of CMF-B. However, there may be differences with regard to defaults units.

### Units

CMF-E will utilize the unit attribute identically to CMF-B, except it may derive a default unit from a different attribute, as follows. For CMF-E, if an e_default_unit exists for the element, it takes precedence over any default_unit that may be defined. If no e_default_unit exists, but a default_unit exists, then default_unit will be utilized. Regardless of which default (if any exist) is utilized, the unit attribute will otherwise function the same as that defined for CMF-B.

### Accuracy

The accuracy attribute will work identically to that defined for CMF-B.

### CMF-E String Data Representation

In CMF-E, the STRING data representation shall function identically to that defined for CMF-B, unless the field is further defined with e_field_type ENUMERABLE_STRING and has e_value_equivalents_rx (rx indicates “receive”-used when decoding when consuming data) and e_value_equivalents_tx (“tx” indicates “transmit”-used when encoding when producing data) definitions.

If a field with field_type STRING is defined with an e_field_type ENUMERABLE_STRING, then the field has the ability to be represented in more than one way, as a regular string in some cases and as an enumerated value in others.

If an e_value_equivalents_tx attribute exists for an ENUMERABLE_STRING and the currently desired value is found in the list of equivalents, then the value is encoded into CMF-E as an enumeration and not a regular STRING. If it does not exist in the e_defined_values_tx attribute list, then it will be encoded as a normal STRING, identically to CMF-B. This allows STRING values to be sent without enumeration, so they can be understood by a consumer with an older DTD/Schema.

The e_value_equivalents_tx list will be constructed of known values for the field, each assigned an individual numeric value (integer). If it exists, that number will be sent in CMF-E. It does have a special encoding and is not passed exactly the same way as a regular CMF-B/E integer.

Additionally, an e_value_equivalents_rx list is used by the decoder to equate the incoming enumeration with the original value.

The two equivalents lists exist separately (one for transmit and one for receive) in order to allow future additions to the enumerations in a backwards compatible manner. The new value must be added to the receive list first (the receive list will be a superset of all values in the transmit list plus any newer values that have been added since the transmit list was updated). Adding to the receive list first allows consumer systems to be prepared for when a new value is encoded as an enumeration. Later, after all consumer systems have implemented a new value (or many new values), then the consumers will be “ready” to have the producers begin producing the new values. At that time the new values can be copied into the transmit list. Until then, any new strings (not found in the transmit list) will be transmitted as a defined ASCII string value (as in CMF-B).

For CMF-E ENUMERABLE_STRING the numeric encoding shall utilize the least significant seven bits, 0-6, of each byte as data (bit 7 is the termination bit), with the exception of the first byte. In the first byte, bit 7 is still the termination bit, but bits 4-6 are reserved and used by the parser of the data to determine whether the data is being sent as a regular string or as the replacement enumerated value. Therefore, bits 4-6 are always “001”.

The first byte is defined as:
Tfffbbbb where T is termination bit (if T=0, 2nd byte follows),
fff are fixed bits “001”
bbbb are the most significant bits of the replacement

A single byte can accommodate values 1-15 (0 is NOT USED):

$$Value 1 = 1 - 001 - 0001$$

$$thru value 15 = 1 - 001 - 1111$$

The second byte and any needed subsequent bytes (for values greater than 15) are combined with the first byte and is defined as:
Tbbbbbbb where
T is termination bit (if T=0, 3rd or more bytes follows),
bbbbbbb are value bits

Two bytes can accommodate values 16-2047:
Value 16=0-001-0000 1-0010000 (note termination bits, and “10000” (16) in least significant/right-most bits)

$$Value 127 = 0 - 001 - 0000 \; 1 - 1111111$$

Value 128=0-001-0001 1-0000000 (value “10000000” crosses least significant bits of first byte and all value bits of second byte)
Value 2047=0-001-1111 1-1111111 (note value “11111111111” fills all value bits)

Three bytes can accommodate values 2048-262143:

$$Value 2048 = 0 - 001 - 0000 \; 0 - 0010000 \; 1 - 0000000$$

(note termination bits, and “100000000000” (2048) in least significant value bytes

This pattern may be continued to as many bytes as needed.

CMF-E Example: The enumerated value for the ENUMERABLE_STRING string “ELEPHANT” assigned an equivalent integer of “12”, (Ch) uses one byte as follows in hexadecimal: “9C”, or in binary: 1-001-1100. Note the termination bit set in the byte.

CMF-E Example: The enumerated value for the ENUMERABLE_STRING string “ZEBRA” assigned an equivalent integer of “75”, (4Bh) uses two bytes as follows in hexadecimal: “10CB”, or in binary: 0-001-0000 1-1001011. Note the termination bit set in the byte.

### CMF-E Pattern Data Representation

The PATTERN representation for CMF-E is identical to that of CMF-B.

### CMF-E Packed Component Data Representation

The PACKED COMPONENT representation for CMF-E is identical to that of CMF-B.

### CMF Constructs

### Value Initialization and Modification

Prior to any data being received for CMF, all element values shall be interpreted as though the producer has “No Data” (i.e., no comment) for the element unless there is an “Initial Value” attribute defined for the element, in which case the receiving host shall utilize the value of the “Initial Value”.

Unless otherwise exempted, an element containing an initial value shall not be present in a package unless its value has changed from the specified initial value, and it shall always be sent if set to other than its initial value.

Receptions of data that don't have a value for an element are to be assumed to mean “No Change” for that element value. In other words, retain the last data sent which could either be a value that was previously sent or the “No Data” or “Initial Value” for data that was never sent. Note that in a CMF-B/CMF-E Packed Component both bits of the value being set (bits=11) are reserved for indicating a “No Change” state or Defaulted.

CMF additionally permits the declaration of “Default Value” attributes that provide the most common value which, when provided by the producer for required elements, is not actually encoded into the data stream for CMF-B/CMF-E. Defaults are not utilized for CMF-X.

Removal of the most common value on transmit and subsequent re-insertion on receipt will result in a space savings to broadcasts. These values shall be handled only by parser software and the removal and insertion is transparent to application software. The values shall be passed to the application software as though they were actually present in the decoded data stream. The removal and insertion operation only occurs when the values are for required elements in their parent content model, the parent element is being sent, and the value provided by the producer matches the defined default. In addition, the removal of default values shall only occur for data encoded for transmittal and shall not occur for direct child elements of COMPOSITE or REPETITIVE elements.

Optional elements that are defined to allow values shall not be reported if the producer has no value to report. For CMF, the absence of an element value in the data stream means the producer had data matching the defined default for a required element, had no data, had no new data, or did not wish to provide data for the element. All but the first are referred to as a “No Change” condition. If the originator never sends an element value, the element value shall remain in either the Initial Value state, if one is defined, or in the No Data state. In contrast to many other formats, for CMF there is no actual value for the No Data state (with the exception of the PACKED data type).

For elements, that data shall be retained as the value for the element without an Initial Value attribute, consumers shall retain reported a value until a new value is received or the originator indicates that the element is reset. Therefore, with the exception of elements with an Initial Value attribute, once a value for an element is received, the receipt of additional data packages that do not contain the element indicates that no change will be made to the previous value and, when data is received for that element, that data replaces the previously received data. Once an element with an Initial Value attribute is reported with something other than its Initial Value, it shall continue to be reported for the duration of the event, or until specifically reset to its Initial Value.

Data for which the content model requires elements to always be sent together, or for which there are individually repeatable elements, will normally also be replaced on the receipt of new data for the group or new repeatable elements. This is the process for all values unless a separate implementation rule is provided to do otherwise.

### Reset

When the originator has previously provided data for an element value and desires to return the element value to the No Data or Initial Value state, CMF provides a special reset indication. For both representations of CMF, an element's value usually can be reset if it has the reset attribute in its definition, but due to differences in the two representations, there are different ways to indicate a reset condition for CMF-X and CMF-B/CMF-E.

Receipt of a reset indication for an element shall indicate to an application that the value for the specified element is to revert to the “No Data” condition unless there is an “Initial Value” attribute defined for the element, in which case the host shall revert to the value of the “Initial Value”.

The reset indicator for CMF-X shall be provided by reporting the reset attribute set to its positive or set (i.e., “Y” for yes) state. For CMF-B/CMF-E, resetting an element value shall be accomplished by sending only one byte for the element value with all bits set to zero including the termination bit. Since zeros in all eight bits is not a normal value for the first byte of any of the defined CMF-B/CMF-E data representations, the all-zero setting provides a unique value to indicate the reset condition. This unique byte is also called the “reset” byte. For all representations only one byte of the value shall be sent containing the reset. The other value bytes of the element, regardless of the defined data representation, shall not be sent. Likewise, some non-FIELD element types may also utilize the reset capability to indicate a reset of all children in their content model and the PACKED element type has some special reset capability for the associated PACKED COMPONENTs. In order to ensure the reset indicator functions correctly, it is critical that the CMF-E enum tags are never assigned to zero.

Before processing each element value or associated sub-component values, consumers shall check for the reset indicator to determine the appropriate element handling.

### Case Sensitivity

Systems shall maintain upper/lower case for CMF (both CMF-B/CMF-E and CMF-X). CMF is case-sensitive during any value checking or value comparison operations. CMF shall also utilize the same case-sensitivity as XML for element names, XML operators, and XML reserved words.

### CMF-X and DTD Whitespace Handling

The XML standard provides limitations on whitespace usage and CMF shall adhere to those limitations. In addition, CMF may impose additional limitations which are described in element name, element value, XML operator, and XML reserved word definitions throughout this standard. For the DTD, whitespace is normally insignificant elsewhere. Consequently, non-printable characters shall be ignored in a DTD. For CMF-X, whitespace is not significant during the parsing operation and node identification. It shall be significant for data verification checking when it can compose part of valid values.

For element attribute DTD declarations having values separated by “|” bars, values which consist of total whitespace between the bars shall be ignored. Thus a bar at the end of a line and another at the beginning of the next line provides the method for performing a line continuation within a declaration. This provides the capability for long attribute declarations in the DTD while maintaining reasonable readability within DTD text edit tools.

### Processing Instructions

CMF provides the capability to process standard XML PIs (Processing Instructions). However, due to the subset capabilities of the CMF binary format, placement of PIs in CMF-X shall be limited to being a child of any element of type GROUP. CMF-B reserves tag value of 0 to indicate a PI so this value shall not be used by any other element in the DTD. CMF-E reserves the QuadBit tag of 119 decimal (FFFFFFFE hex as QuadBit) to indicate a PI so this tag will not be used by any other element in the DTD.

The PI formats for the two types of CMF representations shall take the following forms:

| | |
|---|---|
| CMF-X stream format: | “<?PI_target PI_Value?>” |
| CMF-B stream format: | “binary_tag_zero PI_target_string PI_value_string” |
| CMF-E stream format: | “QuadBit_tag_119 PI_target_string PI_value_string” |

An example of a PI in the three types of CMF representations would be:
CMF-X stream format: “<?TEST 123?>”

### CMF-B Stream Format (in Binary):

“1-0000000 0-1010100 0-1000101 0-1010011 1-1010100 0-0110001 0-0110010 1-0110011”
   Comment: This is the 0 tag, PI_target=“TEST”, and PI_value=“123”. Notice that the termination bits are set in the 1st, 5th, and 8th bytes.

### CMF-E Stream Format (in Binary):

“1111 1111 1111 1111 1111 1111 1111 1110 0-1010100 0-1000101 0-1010011 1-1010100 0-0110001 0-0110010 1-0110011”
   Comment: This is the four-byte QuadBit tag of “119”, PI_target=“TEST”, and PI_value=“123”. Notice that the termination bits are set in the 7th and 11th bytes. No termination bits are needed for the QuadBit tag.

### CMF Elements

CMF is an XML-based hierarchy of nested elements. The root element shall, by definition, always be the first element in the data stream. All other elements shall be contained, or nested, within the root element. Each element in standard XML can contain data content or have other elements nested within it or both. This hierarchical nesting results in a tree structure of elements. For CMF data, the standard XML element constructs shall be utilized to provide five types of packaging elements; FIELD elements, GROUP elements, COMPOSITE elements, REPETITIVE elements, and PACKED elements. Consistent with XML, each of the five types of elements, defined for both CMF-X and CMF-B, shall have certain XML attributes. For CMF, these attributes shall be based upon keywords which are used by a generic CMF parser to efficiently encode, decode, validate, and verify the data elements. The keyword attributes may also be used, if desired, by specialized CMF-X application software to validate, verify, operate on, and/or display the elements.

Data is passed and element type attributes are assigned using the five element types in combination with the six previously detailed data representations: INTEGER, ENUMERATED, FLOAT, STRING, PATTERN, and PACKED COMPONENT. The details of the data representations are provided above. The data representations are each identified as one of six possible “field types” within a specific element type.

As in standard XML, each element has a “content model” in the DTD, which identifies its allowable contents. Content can be either data or other nested “child” elements. Elements that contain data as content shall have “PCDATA” (standard XML terminology for data) in their content model and shall have a “field type” attribute that identifies the data representation of the data value. Note that CMF does NOT support a “mixed content model” which mixes both data and children elements within the content model of an element. Consistent with XML, elements that contain nested children elements shall list the names of other declared CMF elements in their declared DTD content model. The table below shows the five types of CMF elements along with their specific function, associated field types, and allowable children element types.

TABLE
Element Type Utilization

| | | | PERMITTED |
|---|---|---|---|
| ELEMENT | ELEMENT | | CHILDREN |
| TYPE | FUNCTION | FIELD TYPE | ELEMENT TYPES |
| FIELD | Provides data value | INTEGER, | None |
| | | ENUMERATED, | (PCDATA only) |
| | | FLOAT, | |
| | | STRING, | |
| | | PATTERN, | |
| | | PACKED | |
| | | COMPONENT | |
| GROUP | Groups other | N/A | GROUP, COMPOSITE, |
| | elements, some of | | REPETITIVE, PACKED, |
| | which are not always | | FIELD (except PACKED |
| | sent | | COMPONENT) |
| COMPOSITE | Groups other elements | N/A | GROUP, COMPOSITE, |
| | which are always sent | | REPETITIVE, PACKED, |
| | together | | FIELD (except PACKED |
| | | | COMPONENT) |
| REPETITIVE | Groups other elements | N/A | GROUP, COMPOSITE, |
| | which are always sent | | REPETITIVE, PACKED, |
| | together and repeats | | FIELD (except PACKED |
| | them | | COMPONENT) |
| PACKED | Groups two-state | N/A | FIELD (PACKED |
| | PACKED | | COMPONENT only) |
| | COMPONENT | | |
| | elements | | |

### Field Elements

The function of Field elements in CMF is to provide actual data content or values. Like other CMF elements, each Field element can have a number of attributes. Attributes for CMF elements use pre-defined keywords as the attribute names. These attributes may be “REQUIRED” XML attributes meaning they must be sent prior to the element value. Most attributes are “FIXED” XML attributes and therefore are not sent in the data. (The numeric element tag is the exception in that it is ALWAYS sent in CMF-B in place of the XML character-based tags unless the type of element's parent eliminates the tags.) These keywords provide the ability to define, encode, and decode the more bandwidth-efficient binary CMF by providing information about the data elements to the generic CMF-B parser software. If desired, these keywords can also be used by specialized CMF-X applications since both “REQUIRED” and “FIXED” XML attributes are made available to the application level by commercial parsers.

Each Field element DTD declaration contains the following attributes:
a) Element tag (not required if only a sub-component of a REPETITIVE, COMPOSITE, or PACKED)
b) Element type set equal to “FIELD”
c) Field type set equal to “INTEGER”, “ENUMERATED”, “FLOAT”, “STRING”, “PATTERN”, or “PACKED_COMPONENT”
d) Various other optional or element type dependent attributes to identify element value defaults, range (min and/or max), unit selections, accuracy selections, lists of allowed values, etc. The Field DTD element declaration takes the form:

<!ELEMENT Field_Name (#PCDATA)>
<!ATTLIST Field_Name keyword_name keyword_declaration>

where the attribute list (i.e., ATTLIST) is repeated for each keyword applied to the Field element (or at least the contents are repeated—both are acceptable XML forms).

An example DTD declaration for a Field element named “Aircraft_Count” would be:

<!ELEMENT Aircraft_Count (#PCDATA)>
<!ATTLIST Aircraft_Count reset (Y | N) “N”>
<!ATTLIST Aircraft_Count element_tag CDATA #FIXED “1”>
<!ATTLIST Aircraft_Count element_type CDATA #FIXED “FIELD”>
<!ATTLIST Aircraft_Count field_type CDATA #FIXED “INTEGER”>
<!ATTLIST Aircraft_Count lower_range CDATA #FIXED “0”>
<!ATTLIST Aircraft_Count upper_range CDATA #FIXED “100”>

The Field formats for the three types of CMF representations take the following forms:

### CMF-X Stream Format:

“<element name_tag>element_value</element_name_tag>”

### CMF-B or CMF-E Stream Format:

“element_binary_tag element_value”

An example of a Field element in the three types of CMF representations would be:

### CMF-X Stream Format:

“<Aircraft_Count>12</Aircraft_Count>”

### CMF-B Stream Format (in Binary):

“10000001 10001100”

### CMF-E Stream Format (in Binary):

“xxxxxxx 10001100” (tag is as defined by e_child_tags in parent element for Aircraft_Count, the tag may be different if the field belongs to more than one element)
Comment: This is the tag and value=12.

A reset for the Field element in the three types of CMF representations shall take the forms:
CMF-X reset format: “<element_name_tag reset=” Y″> </element_name_tag>” or
“<element_name_tag reset=” Y″/>
CMF-B reset format: “element_binary_tag special_reset_value”
CMF-E reset format: “e_element_binary_tag special_reset_value”
   (e_element_binary_tag is as defined by e_child_tags in parent element for Aircraft_Count)

### Group Elements

Group elements in CMF identify organizational nestings (i.e., groupings) of other elements. For CMF, elements shall be identified as group elements by the presence of an element_type attribute set equal to “GROUP”. A length value shall be sent with Group elements in CMF-B/CMF-E to indicate the end of the group in lieu of the end tag used in CMF-X. For CMF-B, the length value is calculated as the total number of bytes in the group after the length value. For CMF-E, the length is calculated as the total number of half-bytes, also termed “nibbles”, since some of the CMF-E constructs are on half-byte/nibble boundaries. It is inserted as a CMF-B/CMF-E INTEGER value just after the Group tag. For Group elements, the use of the “GROUP” indication combined with the end tag for CMF-X or length value for CMF-B/CMF-E shall be used by the receiving parser to 1) verify receipt of grouping content, 2) identify the location of the end of data or the start of the next group, and 3) if new unrecognized elements are in the group, skip to the end of the group without requiring detailed processing of the unknown group components.

For CMF, the root element acts as the start of document indicator and is by definition the largest group element in that ALL other CMF elements are nested within the data document. Additional uses of group elements in CMF include providing associations of elements in order to group related or similar types of data (e.g., all location-related fields).

Each Group element DTD declaration contains the following:
a. Attributes
   1) Element tag (not required if only a sub-component of a REPETITIVE or COMPOSITE)
   2) Element_Type attribute set equal to “GROUP”
   3) e_child_tags attribute to define CMF-E tags for all immediate child elements
b. One or more other elements declared as sub-elements in the element's content model

The Group DTD element declaration takes the form:

<!ELEMENT Group_Element_Name (content_model_entries)>
<!ATTLIST Group_Element_Name keyword_name
keyword_declaration>

where the attribute list (i.e., ATTLIST) is repeated for each keyword applied to the Group element (or at least the contents are repeated—both are acceptable XML forms).

An example DTD declaration for a Group element named “Cockpit_Readings” would be:

<!ELEMENT Cockpit_Readings (Fuel_Reading, Airspeed_Reading*)>

| | |
|---|---|
| <!ATTLIST Cockpit_Readings reset | (Y \| N) “N”> |
| <!ATTLIST Cockpit_Readings element_tag | CDATA #FIXED “1”> |
| <!ATTLIST Cockpit_Readings element_type | CDATA #FIXED |
| | “GROUP”> |
| <!ATTLIST Cockpit_Readings e_child_tags | CDATA #FIXED |

“Fuel_Reading=1, Airspeed_Reading=2”>

The Group formats for the three types of CMF representations take the following forms:

| | |
|---|---|
| CMF-X | “<element_name_tag>nested_ |
| stream format: | elements</element_name_tag>” |
| CMF-B | “element_binary_tag_length_ |
| stream format: | value_nested_elements” |
| CMF-E | “QuadBit_tag_length_value_ |
| stream format: | nested_elements” |

Note: The length value is required in CMF-B and CMF-E and is a calculated value required upon transmission.

An example of a Group element in the three types of CMF representations would be:
(assuming the parent of Cockpit_Readings defines its e_child_tag as Cockpit_Reading=4, and the Fuel_Reading element is an INTEGER having an element_tag value of 2 and default units of “Gal”)

### CMF-X Stream Format:

“<Cockpit_Readings><Fuel_Reading unit=’Gal’>3</Fuel_Reading>
</Cockpit_Readings>”

CMF-B stream format (in binary): “10000001 10000010 10000010 10000011”
Comment: This is the cockpit readings element_tag, length=2, fuel tag, and fuel value=3.
CMF-E stream format: “0100 10000011 0001 10000011”
Comment: This is the cockpit readings QuadBit tag=4,
length in nibbles=3, fuel reading QuadBit tag=1, and fuel reading value=3.

A reset for all Group elements in the three types of CMF representations shall take the forms:

### CMF-X Reset Format:

“<element_name_tag reset=”Y”>
tags_with_reset=Y_for_required_elements
</element_name_tag>”

CMF-B reset format: “element_binary_tag special_reset_value”
CMF-E reset format: “element_QuadBit_tag special_reset_value”
To reset individual Group elements the forms are:

### CMF-X Reset Format:

“<element_name_tag>nested_components_with_values_and_or_reset
attributes
</element_name_tag>”

### CMF-B Reset Format:

“element_binary_tag length_value
nested_components_with_values_and_or_special_reset_values”

### CMF-E Reset Format:

“element_QuadBit_tag nibble_length_value
nested_components_with_values_and_or_special_reset_values”

### Composite Elements

COMPOSITE elements provide a way in CMF-B and CMF-E, using a single tag, to send a number of element values, all of which are known to always contain data whenever the composite group is transmitted. COMPOSITE elements are useful for CMF-B/CMF-E to conserve bandwidth. COMPOSITE elements are identified by the presence of the “element_type” keyword attribute set to the value “COMPOSITE”.

In CMF-B/CMF-E, the COMPOSITE element results in only the tag for the COMPOSITE element being sent and then all nested element values immediately follow in the order defined in the DTD but without any individual nested element tags. In CMF-X, COMPOSITE elements generate the composite element start tag, each of the nested element values preceded and terminated by their respective tags, and finally the composite element end tag. It should be noted that for CMF-B/CMF-E the only tags excluded by the COMPOSITE element tag are the tags of the first level of nested elements. Any elements nested under the first level of nested elements would be tagged according to their type or their respective first level element type.

Each COMPOSITE element DTD declaration contains the following:
1. Attributes
   a) Element tag (not required if only a sub-component of a REPETITIVE or COMPOSITE)
   b) Element type set equal to “COMPOSITE”
2. One or more other elements declared as sub-elements in the element's content model. All children of a COMPOSITE element must be declared as required elements in the COMPOSITE element's content model.

For CMF-E, no e_child_tags attribute is needed for a COMPOSITE.

The COMPOSITE DTD element declaration takes the form:
<!ELEMENT Composite_Element_Name (content_model_entries)>
<!ATTLIST Composite_Element_Name keyword_name keyword_declaration>
where the attribute list (i.e., ATTLIST) is repeated for each keyword applied to the COMPOSITE element (or at least the contents are repeated—both are acceptable XML forms).

An example DTD declaration for a COMPOSITE element named “Cockpit_Readings” would be:
(assuming the parent of Cockpit_Readings defines its e_child_tag as Cockpit_Reading=4)

<!ELEMENT Cockpit_Readings (Fuel_Reading, Airspeed_Reading)>

| | |
|---|---|
| <!ATTLIST Cockpit_Readings reset | (Y \| N) “N”> |
| <!ATTLIST Cockpit_Readings element_tag | CDATA #FIXED “1”> |
| <!ATTLIST Cockpit_Readings element_type | CDATA #FIXED |
| | “COMPOSITE”> |

The COMPOSITE formats for the three types of CMF representations take the following forms:

### CMF-X Stream Format:

“<element_name_tag>composite_component_elements_with_tags</element_name_tag>”

### CMF-B Stream Format:

“element_binary_tag composite_component_element_values”

### CMF-E Stream Format:

“QuadBit_tag composite_component_element_values”

An example of a COMPOSITE element in the three types of CMF representations would be: (assuming the Fuel_Reading element is an INTEGER having default units of “Gal” and Airspeed_Reading is an INTEGER having a default units of “MPH”)

### CMF-X Stream Format:

“<Cockpit_Readings><Fuel_Reading unit=’Gal’>3</Fuel_Reading>
<Airspeed_Reading unit=’MPH’>110</Airspeed_Reading>
</Cockpit_Readings>”

### CMF-B Stream Format (in Binary):

“10000001 10000011 11101110”
Comment: This is the cockpit readings tag, fuel value=3, and airspeed value=110.

### CMF-E Stream Format:

“0100 10000011 11101110”
Comment: This is the cockpit readings QuadBit tag=4,
   fuel reading value=3,
   and airspeed value=110.

To reset all COMPOSITE elements in the three types of CMF representations the forms are:

### CMF-X Reset Format:

“<element_name_tag reset=”Y”>
tags_with_reset=Y_for_all_sub_elements</element_name_tag>”

CMF-B reset format: “element_binary_tag special_reset_value”
CMF-E reset format: “element_QuadBit_tag special_reset_value”

A reset of a composite element shall reset all children component values. Accordingly, a resettable composite element shall only contain children that are reset capable. Children of a composite shall not be reset individually, but rather the composite and its children shall be reset together. If the children of a composite are resettable, and the composite itself is not, then the children shall not be resettable in this context. The same children may however be resettable when used as children of a different element.

### Repetitive Elements

REPETITIVE elements provide a way to define one or more elements or groupings of elements and repeat them multiple times. REPETITIVE elements are useful for CMF-B/CMF-E to conserve bandwidth. REPETITIVE elements are identified by the presence of the “element_type” keyword attribute and set to the value “REPETITIVE”. REPETITIVE elements also have a “REQUIRED” attribute to provide the number of “element iterations” which shall be included in CMF-B, CMF-E, and CMF-X.

In CMF-B and CMF-E, the REPETITIVE element results in only the tag for the REPETITIVE element being sent, the value representing the number of iterations, and then all nested element values immediately follow in the order defined in the DTD but without any individual nested element tags for the first level of nesting only. The nested element values are repeated as a group, in order, for the number of iterations indicated.

In CMF-X, REPETITIVE elements generate the repetitive element start tag including the number of iterations attribute value. Next, CMF-X provides each of the nested element values preceded and terminated by their respective tags, in accordance with standard XML rules. The nested element tags and values are repeated, in order, for the number of iterations indicated.

For REPETITIVE elements, any follow-on report shall include all elements that are intended by the originator to be maintained by the recipient. Order is significant and shall be maintained. The consuming system shall treat all reporting of REPETITIVE elements as replacements for previously reported values of the element. A reset of the REPETITIVE element shall reset all instances of all nested elements and a reset of one nested element shall reset only that nested element.

Each REPETITIVE element DTD declaration contains the following:
1. Attributes
   a) Element tag (not required if only a sub-component of a REPETITIVE or COMPOSITE)
   b) Element type set equal to “REPETITIVE”
   c) Element iterations value indicating number of repetitions of component elements
2. One or more other elements declared as sub-elements in the element's content model (required individually, but not as a group)

The REPETITIVE DTD element declaration takes the form:

<!ELEMENT Repetitive_Element_Name ((content_model_entries)X)>
<!ATTLIST Repetitive_Element_Name keyword_name
keyword_declaration>

where X must be a “+” if the REPETITIVE element is not reset capable or alternatively, must be a “*” if the REPETITIVE element is enabled for reset capability and where the attribute list (i.e., ATTLIST) is repeated for each keyword applied to the REPETITIVE element (or at least the contents are repeated—both are acceptable XML forms).

An example DTD declaration for a REPETITIVE element named “Cockpit_Readings” would be:

<!ELEMENT Cockpit_Readings ((Fuel_Reading, Airspeed_Reading)*)>

| | |
|---|---|
| <!ATTLIST Cockpit_Readings reset | (Y \| N) “N”> |
| <!ATTLIST Cockpit_Readings element_tag | CDATA #FIXED “7”> |
| <!ATTLIST Cockpit_Readings element_type | CDATA #FIXED “REPETITIVE”> |
| <!ATTLIST Cockpit_Readings element_iterations | CDATA #REQUIRED> |
| <!ATTLIST Cockpit_Readings min_element_iterations | CDATA #FIXED “1”> |
| <!ATTLIST Cockpit_Readings max_element_iterations | CDATA #FIXED “5”> |

The REPETITIVE formats for the three types of CMF representations take the following forms:

### CMF-X Stream Format:

“<element_name_tag element_iterations=element_iterations_value>
repetitive_component_elements_with_tags</element_name_tag>”

### CMF-B Stream Format:

“element_binary_tag element_iterations_value repetitive_component_element_values”

### CMF-E Stream Format:

“element_QuadBit_tag element_iterations_value repetitive_component_element_values”

An example of a REPETITIVE element in the three types of CMF representations would be:
(assuming the Fuel_Reading element is an INTEGER having a default unit of “Gal” and Airspeed_Reading is an INTEGER having a default unit of “MPH”) and assuming the parent of Cockpit_Readings defines its e_child_tag as Cockpit_Reading=4)

### CMF-X Stream Format:

“<Cockpit_Readings element_iterations=2>
   <Fuel_Reading unit=‘Gal’>3</Fuel_Reading>
   <Airspeed_Reading unit=‘MPH’>110</Airspeed_Reading>
   <Fuel_Reading unit=‘Gal’>1</Fuel_Reading>
   <Airspeed_Reading unit=‘MPH’>85</Airspeed_Reading>
</Cockpit_Readings>”

### CMF-B Stream Format (in Binary):

“10000111 10000010 10000011 11101110 10000001 11010101”
Comment: This is the tag, element iterations=2, first fuel value=3, first airspeed value=110, second fuel value=1, and second airspeed value=85.

### CMF-E Stream Format:

“0100 10000010 10000011 11101110 10000001 11010101”
Comment: This is the cockpit readings QuadBit tag=4, element_iterations=2, first fuel value=3, first airspeed value=110, second fuel value=1, and second airspeed value=85.

To reset all REPETITIVE iterations the forms are:

### CMF-X Reset Format:

“<element_name_tag reset=” Y″> </element_name_tag>” or
“<element_name_tag reset=” Y″/>
CMF-B reset format: “element_binary_tag special_reset_value”
CMF-E reset format: “element_QuadBit_tag special_reset_value”
To reset individual REPETITIVE iterations the forms are:

### CMF-X Reset Format:

“<element_name_tag element_iterations=element_iterations_value>
repetitive_components_with_values_and_or_reset_attributes
</element_name_tag>”

### CMF-B Reset Format:

“element_binary_tag element_iterations_value
component_values_and_or_special_reset_values”

### CMF-E Reset Format:

“quadbit_tag element_iterations_value
component_values_and_or_special_reset_values”
   For CMF-B/CMF-E, a reset of the element iterations value shall reset all component values.

### Packed Elements

PACKED elements provide a way to represent two-state (i.e., Boolean) data values such as fields that are on/off, true/false, enabled/disabled, etc. This packaging type provides for efficient transmission of two-state (i.e., Boolean) data elements without introducing non-inherent dependencies between them. PACKED elements are useful for CMF-B/CMF-E to conserve bandwidth. PACKED elements are identified by the presence of the “element_type” keyword attribute set to the value “PACKED” and may only have PACKED COMPONENTs as children in their content model.

In CMF-X, PACKED elements generate the PACKED element start tag, the character values for each of the nested elements preceded and terminated by their respective tags, and finally the PACKED element end tag.

In CMF-B and CMF-E, the PACKED element results in only the tag for the PACKED element being sent and then all nested element values are provided immediately following within a special extensible byte format containing multiple PACKED_COMPONENT data representation elements.

The CMF-B representation of the PACKED COMPONENT is the only case in CMF-B where an individual element is not defined on byte boundaries. For CMF-E, it is the only case besides the QUADBIT e_field_type. In CMF-B/CMF-E rather than individually passing the character values defined for the nested components, all of the sub-components are packed together into a special extensible byte format in the form “TFxxyyzz” where the “T” is the termination bit indicating the final byte of the PACKED value,
the “F” indicates to examine the individual field components or to operate on them as a set (i.e., 0 is illegal for “F” except in normal reset value)
the “xx” is PACKED_component position 1 of byte n,
the “yy” is PACKED_component position 2 of byte n,
and “zz” is PACKED_component position 3 of byte n,
where the maximum n is the number of components divided by 3.
   The “T” works as the termination indicator as it does in all other data representations (0=more bytes to follow, 1=termination or last byte).
   The “F” is the field use indicator and shall always be set to 1 if any fields are being sent and shall only be set to 0 when the reset byte value (reset of entire PACKED element) is sent.

Note that the components in the packed representation are identified as to which position represents them in the structure through the order in which they are defined in the PACKED element content model. The first component declared in the content model is the position 1 component of byte 1. Undefined component positions in the lower significant bits of the final packed byte must always be transmitted as set (i.e., the reserved bit value=3 meaning “no change”).

Trailing bytes (i.e., other than the first value byte) of a PACKED element which do not have new data to report or for
which all three components within the byte are no-change, do not have to be reported. This is true only as long as the components are either optional or are required and have a defined default value which is the current value. Note that this also applies ONLY to bytes occurring after all bytes for which data is being sent.

If an element is required and the value is 3 this means defaulted. If an element is optional and the value is 3 this means “No Change”.

Each PACKED element DTD declaration contains the following:
1. Attributes
   a) Element tag (not required if only a sub-component of a REPETITIVE or COMPOSITE)
   b) Element type set equal to “PACKED”
2. One or more PACKED_COMPONENT (only) elements declared as sub-elements in the element's content model

The PACKED DTD element declaration takes the form:
<!ELEMENT Packed_Element_Name (content_model_entries)>
<!ATTLIST Packed_Element_Name keyword_name keyword_declaration>
where the attribute list (i.e., ATTLIST) is repeated for each keyword applied to the PACKED element (or at least the content is repeated—both are acceptable XML forms).

An example DTD declaration for a PACKED element named “Cockpit_Readings” would be:
<!ELEMENT Cockpit_Readings (Autopilot_Mode, Landing_Gear_Position?)>
<!ATTLIST Cockpit_Readings reset (Y|N)“N”>
<!ATTLIST Cockpit_Readings element_tag CDATA #FIXED “5”>
<!ATTLIST Cockpit_Readings element_type CDATA #FIXED “PACKED”>

An example DTD declaration for a PACKED_COMPONENT element named “Autopilot_Mode” would be:
<!ELEMENT Autopilot_Mode (#PCDATA)>
<!ATTLIST Autopilot_Mode reset (Y|N) “N”>
<!ATTLIST Autopilot_Mode element_type CDATA #FIXED “PACKED COMPONENT”>
<!ATTLIST Autopilot_Mode defined_values CDATA #FIXED “On=1|Off=2”>
<!ATTLIST Autopilot_Mode default_value CDATA #FIXED “Off”>

The PACKED formats for the three types of CMF representations would take the following forms:

### CMF-X Stream Format:

“<element name_tag>nested_packed_component_tags_and_elements
</element_name_tag>”
CMF-B stream format: “element_binary_tag packed_element_value”
CMF-E stream format: “quadbit_tag packed_element_value”

An example of a PACKED element in the three types of CMF representations would be: (assuming two PACKED_COMPONENT elements of: Autopilot_Mode having possible values of “On” or “Off” and Landing_Gear_Position having possible values of “Up” or “Down”)

### CMF-X Stream Format:

“<Cockpit_Readings>
<Autopilot_Mode>Off</Autopilot_Mode>
<Landing_Gear_Position>Up</Landing_Gear_Position>
</Cockpit_Readings>”

### CMF-B Stream Format (in Binary):

“10000101 11100111”
Comment: This is the cockpit readings tag and a byte with autopilot_bits=10, landing_gear_bits=01, and one unused_component_bits=11.

### CMF-E Stream Format (in Binary). Values Work Identically to CMF-B, Only the Tag is Different:

“qqqqqqqq 11100111”
Comment: This is the QuadBit e_child_tag for Cockpit_Readings defined in the parent and a byte with autopilot_bits=10, landing_gear_bits=01, and one unused_component_bits=11.

To reset all defined nested packed component elements, the forms are:

### CMF-X Reset Format:

“<element_name_tag reset=” Y″>
empty_tags_with_reset=Y_for_required_sub_elements
</element_name_tag>”
CMF-B reset format: “element_binary_tag special_reset_value”
CMF-E reset format: “quadbit_e_child_tag special_reset_value”

To reset individual defined nested packed component elements the forms are:

### CMF-X Reset Format:

“<element_name_tag>
nested_packed_components_with_values_or_reset_attributes</element_name_tag>”
CMF-B reset format: “element_binary_tag packed_element_value” where there is an individual reset capability within the element value for each packed component.

### CMF-E Reset Format:

“quadbit_e_child_tag packed_element_value” where there is an individual reset capability within the element value for each packed component

### Document Type Definition (DTD)

A Document Type Definition file defines the structure and characteristics of data used for CMF-B, CMF-E, and CMF-X. CMF, including B, E and X, is defined via a single DTD to which all data participants shall adhere. It is possible to generate separate DTDs to handle special output limitations such as conversion of CMF data to different domains and/or users. It is also possible to embed DTD declarations within XML documents for purposes such as extending the format for system specific data requirements.

### DTD Conventions

The following rules are used to create the DTD.

### Naming Elements and Attributes

CMF element names are indicated in mixed case (i.e., Title Case) alphanumeric characters with an underscore between each separate word. Attribute names (or keywords) are indicated in all lower case alphanumeric characters with an underscore between each separate word. XML standard DTD notation is indicated in all upper case alphanumeric characters with an underscore between each separate word where possible within the standard.

### Element Attributes

CMF elements attributes shall be defined as one of the following types:
a. “REQUIRED”: Used where it is a requirement to always report an attribute value.
b. “FIXED”: Used where it is not necessary to send the attribute value, with the following exceptions:
   (1) The numeric tag shall be sent in CMF-B in place of the standard character based tag unless the type of the element's parent eliminates the tag;
   (2) The value multiplier and value offset attributes shall always be transmitted in instance of CMF-X data.
   (3) For CMF-E, the QuadBit e_child_tag shall be defined in the parent element and sent in the data stream to identify the associated child element;
   (4) For CMF-E, the QuadBit e_root_tag shall be defined in the root element and sent in the data stream in place of the standard character based tag.
c. “IMPLIED”: Used to allow the attribute to optionally be sent in XML but does not allow for an inherent “declared default” in the declaration syntax. Note that the “IMPLIED” attribute is not to be confused with the CMF implied accuracy capability as described above.
d. “enumerated”: XML “enumerated” syntax (not to be confused with the CMF ENUMERATED data representation type) is used to provide a selection of choices for an element. If an attribute defined using “enumerated” syntax is not sent, the attribute value shall be assumed to be equal to the inherent “declared default” for the attribute as provided by the “enumerated” syntax. Examples of CMF element attributes that use the “enumerated” syntax include the ‘reset’ and ‘defined_values’ attributes.

There are pre-defined attribute names or CMF keywords that shall be used in the DTD to define CMF elements. These CMF keywords each have special meaning and provide encoding/decoding information to the specialized CMF-B/CMF-E parser software. Some are also used to provide values (e.g., units, accuracy, etc.) in CMF-X. Any one attribute shall be defined only once for any one element of applicable type.

CMF attributes provide for a number of capabilities including but not limited to:
a. Element values may be restricted by range and/or adjusted by a constant.
b. Default element units may be defined.
c. Unit indication is selectable for some elements via selectable unit attributes.
d. Accuracy indication is selectable for some elements by providing selectable accuracy attributes or accuracy range attributes.

The following tables detail the attributes defined and permitted for CMF elements:

### Table CMF Keyword List

TABLE CMF
Keyword List

| | | APPLICABLE | | | | | |
|---|---|---|---|---|---|---|---|
| | | ELEMENT OR | VALUE | VALUE | VALUE | | |
| | XML | FIELD TYPES | SENT | SENT | SENT | | |
| | ATTRIBUTE | (⁺⁺-see | IN | IN | IN | Purpose | Purpose |
| KEYWORD | TYPE* | definition) | CMF-B | CMF-E | CMF-X | 1 | 2 |
| accuracy | IMPLIED | FLOAT only | Optional | Optional | Optional | Convey Data | |
| accuracy_lower | FIXED | FLOAT only | No | No | No | Limit Field | |
| range | | | | | | Values | |
| accuracy_lower_ | FIXED | FLOAT only | No | No | No | Limit Field | |
| ranges | | | | | | Values | |
| accuracy_qualifier | IMPLIED | FLOAT only | Optional | Optional | Optional | Convey Data | |
| accuracy_upper_ | FIXED | FLOAT only | No | No | No | Limit Field | |
| range | | | | | | Values | |
| accuracy_upper_ | FIXED | FLOAT only | No | No | No | Limit Field | |
| ranges | | | | | | Values | |
| default_accuracies | FIXED | FLOAT only | No | No | No | CMF-B | CMF-E |
| | | | | | | Encoding | Encoding |
| | | | | | | Instruction | Instruction |
| default_accuracy | FIXED | FLOAT only | No | No | No | CMF-B | CMF-E |
| | | | | | | Encoding | Encoding |
| | | | | | | Instruction | Instruction |
| default_unit | FIXED | INTEGER or | No | No | No | CMF-B | CMF-E |
| | | FLOAT | | | | Encoding | Encoding |
| | | | | | | Instruction | Instruction |
| | | | | | | | unless |
| | | | | | | | overridden by |
| | | | | | | | e_default_unit |
| default_value | FIXED | Elements with | No | No | No | CMF-B | CMF-E |
| | | values⁺⁺ | | | | Encoding | Encoding |
| | | | | | | Instruction | Instruction |
| defined_values | FIXED | Elements with | No | No | No | Limit Field | CMF-B & |
| | | values++ | | | | Values | CMF-E |
| | | | | | | | Encoding |
| | | | | | | | Instruction for |
| | | | | | | | ENUMERATED |
| | | | | | | | and |
| | | | | | | | PACKED_ |
| | | | | | | | COMPONENT |
| | | | | | | | ONLY |
| e_child_tags | FIXED | GROUP elements | No | Yes | No | CMF-E | |
| | | only | | | | Encoding | |
| | | | | | | Instruction | |
| e_default_unit | FIXED | FLOAT only | No | No | No | CMF-E | |
| | | | | | | Encoding | |
| | | | | | | Instruction | |
| e_field_type | FIXED | INTEGER or | No | No | No | CMF-E | |
| | | STRING | | | | Encoding | |
| | | | | | | Instruction | |
| e_root_tag | FIXED | GROUP elements | No | Yes | No | CMF-E | |
| | | only | | | | Encoding | |
| | | | | | | Instruction | |
| e_value_ | FIXED | STRING only | No | No | No | CMF-E | |
| equivalents_rx | | AND only if | | | | Decoding | |
| | | e_field type = | | | | Instruction | |
| | | ENUMERABLE_ | | | | | |
| | | STRING | | | | | |
| e_value_ | FIXED | STRING only | No | No | No | CMF-E | |
| equivalents_tx | | AND only if | | | | Encoding | |
| | | e_field type = | | | | Instruction | |
| | | ENUMERABLE_ | | | | | |
| | | STRING | | | | | |
| element_iterations | REQUIRED | REPETITIVE | Yes | Yes | Yes | Limit Element | |
| | | only | | | | Structure | |
| element_pattern | FIXED | PATTERN only | No | No | No | Limit Field | CMF-B & |
| | | | | | | Values | CMF-E |
| | | | | | | | Encoding |
| | | | | | | | Instruction |
| element_tag | FIXED | All elements | Yes | No | No | CMF-B | |
| | | | | | | Encoding | |
| | | | | | | Instruction | |
| element_type | FIXED | All elements | No | No | No | Limit Element | |
| | | | | | | Structure | |
| field_type | FIXED | FIELD elements | No | No | No | Limit Field | |
| | | only | | | | Values | |
| initial_value | FIXED | Elements with | No | No | No | Host | |
| | | values++ | | | | Instructions | |
| max_element | FIXED | REPETITIVE | No | No | No | Limit Element | |
| iterations | | only | | | | Structure | |
| min_element | FIXED | REPETITIVE | No | No | No | Limit Element | |
| iterations | | only | | | | Structure | |
| path_exclusions | FIXED | All optional | No | No | No | Limit Element | Host |
| | | elements | | | | Structure | Application |
| | | | | | | | Instructions |
| relevance | enumerated | All elements | No | No | Yes | Host TDP | |
| | | | | | | Instructions | |
| reset | enumerated | All elements | Optional | Optional | Optional | Convey Data | |
| unit | IMPLIED | INTEGER or | No | No | Yes | Convey Data | |
| | | FLOAT | | | | | |
| unit_equivalents | FIXED | FLOAT only | Optional | Optional | No | CMF-B | CMF-E |
| | | | | | | Encoding | Encoding |
| | | | | | | Instruction | Instruction |
| value_lower_range | FIXED | INTEGER or | No | No | No | Limit Field | |
| | | FLOAT | | | | Values | |
| value_lower_ | FIXED | FLOAT only | No | No | No | Limit Field | |
| range_exclusive | | | | | | Values | |
| value_lower_ranges | FIXED | FLOAT only | No | No | No | Limit Field | |
| | | | | | | Values | |
| value_lower | FIXED | FLOAT only | No | No | No | Limit Field | |
| ranges_exclusive | | | | | | Values | |
| value_max_length | FIXED | STRING only | No | No | No | Limit Field | |
| | | | | | | Values | |
| value_min_length | FIXED | STRING only | No | No | No | Limit Field | |
| | | | | | | Values | |
| value_multiplier | FIXED | INTEGER only | No | No | Yes | Host | |
| | | | | | | Instructions | |
| value_offset | FIXED | INTEGER only | No | No | Yes | Host | |
| | | | | | | Instructions | |
| value_qualifier | IMPLIED | INTEGER or | Optional | Optional | Optional | Convey Data | |
| | | FLOAT | | | | | |
| value_upper_range | FIXED | INTEGER or | No | No | No | Limit Field | |
| | | FLOAT | | | | Values | |
| value_upper_ | FIXED | FLOAT only | No | No | No | Limit Field | |
| range_exclusive | | | | | | Values | |
| value_upper_ranges | FIXED | FLOAT only | No | No | No | Limit Field | |
| | | | | | | Values | |
| value_upper_ | FIXED | FLOAT only | No | No | No | Limit Field | |
| ranges_exclusive | | | | | | Values | |

*Note:
With the exception of the value_multiplier and value_offset, attributes declared in the DTD with the XML attribute type of FIXED shall NEVER be transmitted in instances of CMF-X data.

*Note: With the exception of the value_multiplier and value_offset, attributes declared in the DTD with the XML attribute type of FIXED shall NEVER be transmitted in instances of CMF-X data.

### Table CMF Keyword Definitions

TABLE
CMF Keyword Definitions

| KEYWORD | DEFINITION |
|---|---|
| accuracy | The declaration of this attribute |
| | permits accuracy to be reported |
| | (other than just implied). Optionally |
| | reported as a value within |
| | separate upper and lower accuracy |
| | ranges to override the implied |
| | accuracy for a reported element |
| | value. Absence of one or more of |
| | the range limitations leaves any |
| | respective range unrestricted. |
| | Reported as character scientific |
| | notation for CMF-X and as |
| | FLOAT for CMF-B/CMF-E. |
| accuracy_lower_range | Provides the lower range or |
| | minimum value allowed for the |
| | “accuracy” attribute value. |
| accuracy_lower_ranges | Provides the lower ranges or |
| | minimum values for each of the |
| | selectable units of an element |
| | allowed for the “accuracy” attribute |
| | value. |
| accuracy_qualifier | Indicates that the true accuracy |
| | is actually something “less than” |
| | or “greater than” the accuracy |
| | reported in the FLOAT element |
| | accuracy. CMF-B/CMF-E identifies |
| | this qualification via special |
| | bits in an extension byte. Without |
| | this attribute the “greater than” |
| | and “less than” capabilities are |
| | not usable on a FLOAT element |
| | (FLOAT special bits = 0). If this |
| | attribute is declared for an |
| | element and is set to one of the |
| | qualifiers by the producer, it shall |
| | always be presented to users in |
| | some manner, whenever the |
| | related value is presented. It |
| | shall also be included in all |
| | respective instances of CMF data. |
| accuracy_upper_range | Provides the upper range or |
| | maximum value allowed for the |
| | “accuracy” attribute value. |
| accuracy_upper_ranges | Provides the upper ranges or |
| | maximum values for each of the |
| | selectable units of an element |
| | allowed for the “accuracy” attribute |
| | value. |
| default_accuracies | Provides the same type information |
| | as the “default_accuracy” |
| | keyword, but provides multiple |
| | default accuracy values for when |
| | more than one possible unit is |
| | defined for the element. |
| default_accuracy | Provides an accuracy to be assumed |
| | on data receipt in lieu of that |
| | indicated inherently by the floating |
| | point value transmitted. The |
| | accuracy indicated by this attribute |
| | is overridden if the “accuracy” |
| | attribute value is reported with |
| | the element value. |
| default_unit | Provides the unit to be assumed on |
| | data receipt in the absence of a |
| | transmitted unit. For FLOAT |
| | elements, can be overridden by a |
| | “unit” attribute sent in CMF-X |
| | or a unit equivalent value sent in |
| | CMF-B/CMF-E. Additionally, a |
| | different e_default_unit may be |
| | defined for CMF-E, that replaces |
| | the default_unit. |
| default_value | Provides the most common value |
| | which, when provided by the |
| | producer for required elements, is |
| | not actually transmitted. This |
| | attribute is not applicable to FLOAT |
| | or PATTERN elements. It |
| | shall be ignored for optional |
| | elements. These values are passed |
| | to the host as though they were |
| | actually transmitted. |
| defined_values | Provides an allowable set of |
| | values for an element. Not |
| | applicable for FLOAT and |
| | PATTERN elements. The values |
| | may be provided directly in the |
| | DTD as a character string |
| | representation or enumeration |
| | of values each separated by an |
| | option indicator (i.e., the “\|” |
| | character). The values may |
| | alternatively be provided by |
| | reference to the allowable list via |
| | the XML DTD entity reference |
| | capability. Each element may only |
| | reference one external file. |
| e_child_tags | For CMF-E only. Defines the |
| | context-sensitive tags used for the |
| | child elements in a GROUP for |
| | CMF-E. Sent as a QuadBit. |
| e_default_unit | For CMF-E only. Provides the unit |
| | to be assumed on data receipt |
| | in the absence of a transmitted unit |
| | for CMF-E, only. For FLOAT |
| | elements, can be overridden by a |
| | unit equivalent value sent in |
| | CMF-E. Takes precedence over |
| | “default_unit” for CMF-E. |
| e_field_type | For CMF-E only. Further defines |
| | elements of certain “field_type” |
| | to enhance bandwidth savings in CMF-E. |
| | For field_type = ENUMERATED, an |
| | e_field_type = |
| | QUADBIT_ENUMERATED |
| | may be defined in order to use |
| | QuadBit encoding instead |
| | of normal integer encoding |
| | for the value. Likewise, for |
| | field_type = INTEGER, an e- |
| | field_type = QUADBIT_INTEGER |
| | would utilize QuadBit |
| | encoding. For STRING types, the |
| | e_field_type = ENUMERABLE_ |
| | STRING does not “replace” the |
| | STRING, but rather works along |
| | with the STRING capability. |
| e_root_tag | For CMF-E only. Assigns the tag |
| | for a root element. All other |
| | tags are assigned in their parent |
| | element via e_child_tags, but the |
| | root does not have a parent element |
| | to provide that function. |
| e_value_equivalents_rx | For CMF-E only. Defines the |
| | enumerations for used for decoding |
| | ENUMBERABLE_STRING fields. |
| | May have more enumerations defined |
| | than its counterpart |
| | e_value_equivalents_tx, |
| | but not less. |
| e_value_equivalents_tx | For CMF-E only. Defines the |
| | enumerations allowed to be used |
| | for encoding ENUMERABLE_ |
| | STRING fields. If an enumeration |
| | does not exist for a desired string, |
| | then the ASCII string form will |
| | be sent. |
| element_iterations | Provides the number of repetitions |
| | of all elements that are present |
| | within a “REPETITIVE” type |
| | group element. |
| element_pattern | Defines the allowable format of a |
| | PATTERN element using a set |
| | of field indicators. |
| element_tag | Used by CMF-B in place of the |
| | standard XML character-based |
| | start tags. Provided to indicate |
| | the start (or presence) of some |
| | CMF-B elements. Each tag must |
| | be uniquely defined within the |
| | DTD. The special tag value of |
| | “0” is reserved by CMF-B to |
| | indicate a Processing Instruction |
| | and must not be used for element |
| | tags. Element tags are not used |
| | by CMF-E, which uses |
| | e_child_tags and e_root_tag instead. |
| element_type | Used to indicate the type of the |
| | element being defined. The type |
| | must be one of the CMF-B/CMF-E |
| | element types. The possible |
| | values for this attribute are |
| | “GROUP”, “FIELD, “COMPOSITE”, |
| | “REPETITIVE”, or “PACKED”. |
| field_type | Used to indicate the data representation |
| | type of the FIELD element being defined. |
| | The type can be one of the CMF-B/CMF- |
| | E data representation types, including |
| | “INTEGER”, “ENUMERATED ”, |
| | “FLOAT”, “STRING”, “PATTERN”, or |
| | “PACKED COMPONENT” |
| initial_value | Provides a value to be assumed by a |
| | host system initially, when an |
| | element has never been transmitted, |
| | or when an element is reset. |
| | This attribute is not applicable |
| | to FLOAT elements. |
| max_element_iterations | Provides the maximum number of |
| | repetitions of elements within a |
| | “REPETITIVE” type group |
| | element. If this keyword is not |
| | specified, the maximum number |
| | of repetitions is unlimited. |
| min_element_iterations | Provides the minimum number of |
| | repetitions of elements within a |
| | “REPETITIVE” type group |
| | element. If this keyword is not |
| | specified, the minimum number |
| | of repetitions is one. |
| path_exclusions | Identifies a list of paths to which |
| | the element is not to be |
| | reported on. The paths are each |
| | defined as “n” where “n” is a |
| | path number pre-assigned to a |
| | transmission medium or channel. |
| | The excluded paths are each |
| | separated by an option indicator |
| | (i.e., the “\|” character) in the DTD |
| | exclusion declaration. |
| | Required elements cannot be |
| | excluded and thus cannot have |
| | this attribute. |
| relevance | Indicates the operational relevance |
| | of an element. In support of |
| | DTD element maintenance, this |
| | attribute may be declared for |
| | elements which, due to backward |
| | compatibility concerns, cannot |
| | easily be removed from the DTD. |
| | If this attribute is declared for |
| | an element and the attribute value |
| | is “DISUSED”, the respective |
| | element is not operationally valid |
| | and, where possible, shall not |
| | be utilized and/or an indication |
| | shall be presented to the operator. |
| reset | Indicates whether the element is |
| | to be reset to the No Data or |
| | Initial Value state. Valid “reset” |
| | attribute values are “Y” for yes |
| | or “N” for no. The attribute is not |
| | required to be sent with the |
| | “N” value. If the reset condition |
| | is to be indicated, the character |
| | “Y” value is sent in CMF-X or |
| | the special zero value is sent in |
| | CMF-B/CMF-E. Presence of |
| | the reset condition normally |
| | inhibits the transmission of |
| | other non-required attributes. |
| unit | The character representation of the |
| | unit selection is transmitted in |
| | CMF-X. The “unit” attribute is |
| | declared along with one or |
| | multiple possible character unit |
| | selections (using XML |
| | “IMPLIED” attribute syntax). |
| | If defined and available, the unit |
| | indication is always provided for |
| | the “composite path” unless the |
| | element is reset. |
| | For INTEGER elements, only one |
| | unit selection may be defined. |
| | Only that unit selection is |
| | transmitted in CMF-X and no unit |
| | indication is transmitted |
| | in CMF-B/CMF-E. |
| | For FLOAT elements, unit is |
| | optionally reported on CMF-X as |
| | one of the defined set of unit |
| | selections in order to indicate the |
| | unit and/or override any default |
| | unit for a reported element value. |
| | On CMF-B/CMF-E the equivalent |
| | numerical enumerations of the |
| | character unit selections are |
| | provided in a “unit_equivalents” |
| | attribute. The enumeration value |
| | is sent in CMF-B/CMF-E and |
| | the special unit extension |
| | bit is set to one. |
| | Without the unit attribute defined |
| | for an element, unit indication |
| | and FLOAT selectable unit |
| | capability are not supported on the |
| | element (special unit bit = 0). |
| unit_equivalents | Provides the respective enumerations |
| | (i.e., numerical values) for |
| | each possible character unit |
| | selection defined for the “unit” |
| | attribute of a FLOAT element. |
| | Permits numerical indication of |
| | unit selection in CMF-B/CMF-E |
| | (see unit attribute definition). |
| value_lower_range | Identifies the minimum allowed |
| | value for INTEGER or FLOAT |
| | elements inclusive of the range |
| | value itself. If a lower range is |
| | not specified for an INTEGER |
| | or FLOAT element, the lower |
| | range is either zero or unrestricted, |
| | respectively. |
| value_lower_range_ | Identifies the minimum allowed |
| exclusive | value for FLOAT elements |
| | exclusive of the range value |
| | itself (i.e., the reportable minimum |
| | is the lowest value which can be |
| | represented by the producer's |
| | accuracy capability yet higher |
| | than the exclusive value). |
| value_lower_ranges | Identifies the minimum allowed |
| | values for each of the selectable |
| | units for FLOAT elements |
| | inclusive of the range values |
| | themselves. |
| value_lower_ranges_ | Identifies the minimum allowed |
| exclusive | values for each of the selectable |
| | units for FLOAT elements |
| | exclusive of the range values |
| | themselves (i.e., the reportable |
| | minimums are the lowest values |
| | which can be represented by the |
| | producer's accuracy capability |
| | yet higher than the exclusive values). |
| value_max_length | Identifies the maximum number |
| | of characters allowed in a |
| | STRING element value. If there |
| | is no value_max_length |
| | keyword specified for the |
| | element, the maximum length is |
| | unlimited. |
| value_min_length | Identifies the minimum number |
| | of characters required in a |
| | STRING representation element |
| | value. If value_min_length is |
| | not specified for an element, |
| | the minimum length is one. |
| value_multiplier | Provides a constant with which |
| | to multiply the transmitted value |
| | to determine the actual reported |
| | value. This constant multiplier |
| | allows for more efficient usage |
| | of bandwidth by reducing the |
| | transmitted size of integers or |
| | by allowing what would normally |
| | be reported as multiples of a |
| | fixed point value to be transmitted |
| | in the more space efficient INTEGER. |
| | Due to resulting limited |
| | extensibility, this attribute |
| | should be utilized sparingly. |
| | If this attribute is declared for an |
| | element, it shall be included in |
| | all respective instances of CMF-X data. |
| | If the value_offset is used in |
| | conjunction with value_multiplier |
| | the precedence for transmit is |
| | value_multiplier then value_offset |
| | and the reverse is true for the receiver. |
| | transmitter: CMF value = |
| | (real value / value_multiplier)- |
| | value_offset |
| | receiver: real value = |
| | (CMF value + value_offset) * |
| | value_multiplier |
| value_offset | Provides a constant with which to |
| | add to the transmitted value to |
| | determine the actual reported |
| | value. This constant offset allows |
| | for more efficient usage of |
| | bandwidth by allowing what would |
| | normally be reported as a fixed |
| | point value to be transmitted in |
| | the more space efficient INTEGER |
| | or what is normally a |
| | negative integer to be scaled |
| | fully into the non-negative |
| | INTEGER range. Due to resulting |
| | limited extensibility, this |
| | attribute should be utilized |
| | sparingly. If this attribute is declared |
| | for an element, it shall be included |
| | in all respective instances of |
| | CMF-X data. |
| | If the value_offset is used in |
| | conjunction with value_multiplier |
| | the precedence for transmit is |
| | value_multiplier then value_offset |
| | and the reverse is true for the receiver. |
| | transmitter: CMF value = |
| | (real value / value_multiplier)- |
| | value_offset |
| | receiver: real value = |
| | (CMF value + value_offset) * |
| | value_multiplier |
| value_qualifier | In CMF-X, indicates that the true |
| | value is actually something |
| | “less than” or “greater than” the |
| | element value reported in the |
| | INTEGER or FLOAT element |
| | value. For FLOAT elements, |
| | CMF-B/CMF-E identifies this |
| | qualification via special bits in an |
| | extension byte. For INTEGER |
| | elements, CMF-B/CMF-E |
| | identifies this qualification via |
| | respective decrement or |
| | increment of the lower and upper |
| | range values. Without this |
| | attribute the “greater than” and |
| | “less than” capabilities are not |
| | usable on an INTEGER or FLOAT |
| | element (FLOAT special |
| | bits = 0). If this attribute is declared |
| | for an element and is set to |
| | one of the qualifiers by the producer, |
| | it shall always be presented |
| | to users in some manner, |
| | whenever the related value is |
| | presented. It shall also be included |
| | in all respective instances of |
| | CMF data |
| value_upper_range | Identifies the maximum allowed |
| | value for INTEGER or FLOAT |
| | elements inclusive of the range |
| | value itself. If an upper range is |
| | not specified for an element, the |
| | upper range is unrestricted. |
| value_upper_range_ | Identifies the maximum allowed |
| exclusive | value for FLOAT elements |
| | exclusive of the range value |
| | itself (i.e., the reportable maximum |
| | is the highest value which can |
| | be represented by the producer's |
| | accuracy capability yet less |
| | than the exclusive value). |
| value_upper_ranges | Identifies the maximum allowed |
| | values for each of the selectable |
| | units for FLOAT elements |
| | inclusive of the range values |
| | themselves. |
| value_upper_ranges_ | Identifies the maximum allowed |
| exclusive | values for each of the selectable |
| | units for FLOAT elements |
| | exclusive of the range values |
| | themselves (i.e., the reportable |
| | maximums are the highest values |
| | which can be represented by the |
| | producer's accuracy capability |
| | yet less than the exclusive values). |

### CMF Data Validation and Verification

As mentioned previously, XML prescribes two terms for the checking of data; “well-formed” and “valid”. All XML data shall be “well-formed” in that it shall follow the standard XML syntax for identifying elements and providing values. Being “well-formed” does not guarantee that XML data adheres to any specific content model structure or that the data is limited to any definite elements or data attributes, but only ensures proper syntax and nesting. Authentication of the content model structure as well as application of element and attribute limitations is called “validation” by the XML standard. Validation of the data is done against the structure, elements and attributes as declared in a DTD, therefore use of a DTD is required for data validation. XML also provides a defined syntax and structure that shall be applied to a DTD, as DTDs shall always be both “well-formed” and “valid”.

The XML standard allows for an XML parser to check that XML data is “well-formed” without also checking if it is “valid”. XML parsers which also check data validity are called “validating parsers”. A CMF Parser Library may selectively operate as a “validating parser” on CMF-X data, but since it is not physically possible to parse CMF-B/CMF-E data without a DTD, CMF-B/CMF-E data shall ALWAYS be validated.

CMF is consistent in the use of “well-formed” and “valid” as defined by the XML standard. CMF also extends the criterion of DTD validation to ensure that the syntax and structure of a CMF DTD meets the enhanced syntax and structure required by the CMF implementation to include the CMF-defined keyword attributes.

CMF-X being a subset implementation follows the XML standard for “well-formed” and “valid”. CMF-B/CMF-E being a binary derivative clearly does not follow the exact rules, but follows corollary and equivalent rules for “well-formed” as identified above and utilizes the same DTD as CMF-X for data validation.

Additionally, CMF provides for “verification” of the CMF-defined keyword attributes and rules against CMF data as an additional data-checking criterion. “Verification” is the checking of CMF data against the DTD-defined ranges, units, accuracies, resets, etc. Verification of data can only occur if the data is also validated. CMF verification applies to both CMF-X and CMF-B/CMF-E.

### Example DTD Text View

### Package Delivery System DTD File

The following example DTD file provides a hypothetical but representative example of the defined capabilities of CMF. The example DTD, with a file name of “Package_Delivery_System.dtd”, would be located in the same directory as the example XML data. Working examples of CMF-X, CMF-B, and CMF-E based upon this example DTD, are provided below.

### Package Delivery System External Mnemonics File

The example Package_Delivery_System XML data utilizes one external file named “state abbreviation_file.txt” in a directory named “PDS_Mnemonics” which must be a direct sub-directory of the directory containing the DTD. The table below lists example contents of the example external file.

TABLE
PDS External Mnemonics File Listing
AB|AL|AR|TX|OK|KS

### D.6 CMF Data Examples

The following examples provide a representative example of the defined capabilities using the DTD provided in this document.

### Combined CMF-X, CMF-B, CMF-E Example

The example below has the CMF-X representation on the left side of the page, the CMF-B representation in the middle, and the CMF-E representation on the right.

### Combined CMF-X, CMF-B, and CMF-E Example Listing

| | CMF-B | | CMF-E | |
|---|---|---|---|---|
| CMF-X | Note | CMF-B | Note | CMF-E |
| <CMF_Doc> | Tag = 1 | 1_0000001 | Tag = 1 | 0001 |
| | Length | 0_0000001 | Length | 00000010 |
| | | 1_1000010 | | 11101011 |
| <Package_Description_ | Tag = 100 | 1_1100100 | Tag = 1 | 0001 |
| Data> | | | | |
| <Major_Parser_API_ | 2 | 1_0000010 | 2 | 0011 |
| Version>2</Major_Parser_ | | | | |
| API_Version> | | | | |
| <Minor_Parser_API_ | 4 | 1_0000100 | 4 | 0101 |
| Version>4</Minor_Parser_ | | | | |
| API_Version> | | | | |
| <Major_DTD_Version>1 | 1 | 1_0000001 | 1 | 0010 |
| </Major_DTD_Version> | | | | |
| <Minor_DTD_Version> 1 | 1 | 1_0000001 | 1 | 0010 |
| </Minor_DTD_Version> | | | | |
| </Package_Description_ | | | | |
| Data> | | | | |
| <Time_Of_Generation> | Tag = 2 | 1_0000010 | Tag = 2 | 0010 |
| <Date>02-26-01</Date> | 02 | 1_0000010 | 02 | 10000010 |
| | Dash | 1_0101101 | Dash | 10101101 |
| | 26 | 1_0011010 | 26 | 10011010 |
| | Dash | 1_0101101 | Dash | 10101101 |
| | 01 | 1_0000001 | 01 | 10000001 |
| <Time>08:10:20</Time> | 08 | 1_0001000 | 08 | 10001000 |
| | Colon | 1_0111010 | Colon | 10111010 |
| | 10 | 1_0001010 | 10 | 10001010 |
| | 20 | 1_0010100 | 20 | 10010100 |
| </Time_Of_Generation> | | | | |
| <Report_Content> | Tag = 3 | 1_0000011 | Tag = 3 | 0011 |
| | Length | 0_0000001 | Length | 00000010 |
| | | 1_0100110 | | 10111110 |
| <Transportation_Type> | Tag = 4 | 1_0000100 | Tag = 1 | 0001 |
| | Length | 1_0010111 | Length | 10101011 |
| <Truck> | Tag = 5 | 1_0000101 | Tag = 1 | 0001 |
| <Mileage> 1000</Mileage> | 1000 | 0_0000111 | 1000 | 00000111 |
| | | 1_1101000 | | 11101000 |
| <Last_Service_Date> | | | | |
| <Date>12-10-00</Date> | 12 | 1_0001100 | 12 | 10001100 |
| | Dash | 1_0101101 | Dash | 10101101 |
| | 10 | 1_0001010 | 10 | 10001010 |
| | Dash | 1_0101101 | Dash | 10101101 |
| | 00 | 1_0000000 | 00 | 10000000 |
| </Last_Service_Date> | | | | |
| <License_Number> | BR54900 | 0_1000010 | BR54900 | 01000010 |
| BR54900</License_ | | 0_1010010 | | 01010010 |
| Number> | | 0_0110101 | | 00110101 |
| | | 0_0110100 | | 00110100 |
| | | 0_0111001 | | 00111001 |
| | | 0_0110000 | | 00110000 |
| | | 1_0110000 | | 10110000 |
| </Truck> | | | | |
| <Max_Weight_Capability | Tag = 7 | 1_0000111 | Tag = 3 | 0011 |
| unit=″LBS″ | | | | |
| accuracy=″0.5″>1</Max_ | | | | |
| Weight_Capability> | | | | |
| | 1 | 1_0000001 | 1 | 10000001 |
| | E0 | 0_0000000 | E0 | 00000000 |
| | Accuracy | 1_0100000 | Accuracy | 10100000 |
| | 5 | 1_0000101 | 5 | 10000101 |
| | E-1 | 1_0100001 | E-1 | 10100001 |
| <Delivery_Cycle_Time | Tag = 8 | 1_0001000 | Tag = 4 | 0100 |
| unit=″HOURS″>22 | | | | |
| </Delivery_Cycle_Time> | | | | |
| | 22 | 1_0010110 | 22 | 10010110 |
| </Transportation_Type> | | | | |
| <Driver_Information> | Tag = 9 | 1_0001001 | Tag = 2 | 0010 |
| | Length | 1_0011000 | Length | 10101100 |
| <Name>JOHN DOE | Tag = 10 | 1_0001010 | Tag = 1 | 0001 |
| </Name> | JOHN | 0_1001010 | JOHN | 01001010 |
| | DOE | 0_1001111 | DOE | 01001111 |
| | | 0_1001000 | | 01001000 |
| | | 0_1001110 | | 01001110 |
| | | 0_0100000 | | 00100000 |
| | | 0_1000100 | | 01000100 |
| | | 0_1001111 | | 01001111 |
| | | 1_1000101 | | 11000101 |
| <Employee_Number>1364 | Tag = 11 | 1_0001011 | Tag = 2 | 0010 |
| </Employee_Number> | | | | |
| | 1364 | 0_0001010 | 1364 | 00001010 |
| | | 1_1010100 | | 11010100 |
| <Route_Delivery_Number> | Tag = 12 | 1_0001100 | Tag = 3 | 0011 |
| AA53000</Route_ | | | | |
| Delivery_Number> | | | | |
| | AA | 0_1000001 | AA | 01000001 |
| | | 1_1000001 | | 11000001 |
| | 53000 | 0_0000011 | 53000 | 00000011 |
| | | 0_0011110 | | 00011110 |
| | | 1_0001000 | | 10001000 |
| <Route_Delivery_Number> | Tag = 12 | 1_0001100 | Tag = 3 | 0011 |
| AA54000</Route_ | | | | |
| Delivery_Number> | | | | |
| | AA | 0_1000001 | AA | 01000001 |
| | | 1_1000001 | | 11000001 |
| | 54000 | 0_0000011 | 54000 | 00000011 |
| | | 0_0100101 | | 00100101 |
| | | 1_1110000 | | 11110000 |
| </Driver_Information> | | | | |
| <Package_Information | Tag = 13 | 1_0001101 | Tag = 3 | 0011 |
| element_iterations=″2″> | | | | |
| | | 1_0000010 | | 10000010 |
| <Package_Delivery | Iter. = 2 | 1_0000010 | Iter. = 2 | 10000010 |
| element_iterations=″2″> | | | | |
| <Box> | | | | |
| <Dimensions> | | | | |
| <Width | 5 | 1_0000101 | 5 | 10000101 |
| unit=″INCHES″>5 | | | | |
| </Width> | | | | |
| | E0 | 1_0000000 | E0 | 10000000 |
| <Depth | 60 | 1_0111100 | 60 | 10111100 |
| unit=″INCHES″>60 | | | | |
| </Depth> | | | | |
| | E0 | 1_0000000 | E0 | 10000000 |
| <Height | 70 | 1_1000110 | 70 | 11000110 |
| unit=″INCHES″>70 | | | | |
| </Height> | | | | |
| | E0 | 1_0000000 | E0 | 10000000 |
| </Dimensions> | | | | |
| <Weight | 1000 | 0_0000111 | 1000 | 00000111 |
| unit=″LBS″>1000 | | 1_1101000 | | 11101000 |
| </Weight> | | | | |
| | E0 | 1_0000000 | E0 | 10000000 |
| </Box> | | | | |
| <Handling_Instructions> | NO YES | 1_1110111 | NO YES | 11110111 |
| | NO | | NO | |
| <Fragile>NO</Fragile> | | | | |
| <Upright_Only>YES</ | | | | |
| Upright_Only> | | | | |
| <Two_Man_Lift>NO | | | | |
| </Two_ManLift> | | | | |
| </Handling_Instructions> | | | | |
| <Receipt_Instructions> | OPEN NO | 1_1011111 | OPEN NO | 11011111 |
| | NO | | NO | |
| <Open_Instructions> | | | | |
| OPEN_IMMEDIATELY | | | | |
| </Open_Instructions> | | | | |
| <Additional_Boxes>NO | | | | |
| </Additional_Boxes> | | | | |
| <Private>NO</Private> | | | | |
| </Receipt_Instructions> | | | | |
| <Tracking_Number> | ABC | 0_1000001 | ABC | 01000001 |
| ABC22</Tracking_ | | 0_1000010 | | 01000010 |
| Number> | | 1_1000011 | | 11000011 |
| | 22 | 1_0010110 | 22 | 10010110 |
| <Box> | | | | |
| <Dimensions> | | | | |
| <Width unit=″CM″>5 | 5 | 1_0000101 | 5 | 10000101 |
| </Width> | E0 | 0_0000000 | E0 | 00000000 |
| | Units of | 1_1000000 | Units of | 11000000 |
| | CM | 1_0000010 | CM | 10000010 |
| <Depth unit=″INCHES″ | 60 | 1_0111100 | 60 | 10111100 |
| accuracy=″2″>60</Depth> | | | | |
| | E0 | 0_0000000 | E0 | 00000000 |
| | Acc. of | 1_0100000 | Acc. of | 10100000 |
| | 2 | 1_0000010 | 2 | 10000010 |
| | E0 | 1_0000000 | E0 | 10000000 |
| <Height unit=″CM″ | 70 | 1_1000110 | 70 | 11000110 |
| accuracy=″2″>70</Height> | | | | |
| | E0 | 0_0000000 | E0 | 00000000 |
| | Acc & | 1_1100000 | Acc & | 11100000 |
| | Unit | | Unit | |
| | Unit = CM | 1_0000010 | Unit = CM | 10000010 |
| | Acc = 2 | 1_0000010 | Acc = 2 | 10000010 |
| | E0 | 1_0000000 | E0 | 10000000 |
| </Dimensions> | | | | |
| <Weight unit=″LBS″ | 1000 | 0_0000111 | 1000 | 00000111 |
| value_qualifier= | | 1_1101000 | | 11101000 |
| ″GREATER_THAN″> | | | | |
| 1000</Weight> | Exp. | 0_0000000 | Exp. | 00000000 |
| | 0 | 0_0000000 | 0 | 00000000 |
| | Qual: '>' | 1_0100000 | Qual: '>' | 10100000 |
| </Box> | | | | |
| <Handling_Instructions> | YES NO | 1_1011111 | YES NO | 11011111 |
| | NO | | NO | |
| <Fragile> YES</Fragile> | | | | |
| <Upright_Only>NO</ | | | | |
| Upright_Only> | | | | |
| <Two_Man_Lift>NO</ | | | | |
| Two_ManLift> | | | | |
| </Handling_Instructions> | | | | |
| <Receipt_Instructions> | OPEN NO | 1_1011111 | OPEN NO | 11011111 |
| | NO | | NO | |
| <Open_Instructions> | | | | |
| OPEN_IMMEDIATELY | | | | |
| </Open_Instructions> | | | | |
| <Additional_Boxes>NO | | | | |
| </Additional_Boxes> | | | | |
| <Private>NO</Private> | | | | |
| </Receipt_Instructions> | | | | |
| <Tracking_Number>JKL78 | JKL | 0_1001010 | JKL | 01001010 |
| </Tracking_Number> | | 0_1001011 | | 01001011 |
| | | 1_1001100 | | 11001100 |
| | 78 | 1_1001110 | 78 | 11001110 |
| </Package_Delivery> | | | | |
| <Delivery_Address> | | | | |
| <Street> 123 PINE</Street> | 123 | 0_0110001 | 123 | 00110001 |
| | <blank> | 0_0110010 | <blank> | 00110010 |
| | PINE | 0_0110011 | PINE | 00110011 |
| | | 0_0100000 | | 00100000 |
| | | 0_1010000 | | 01010000 |
| | | 0_1001001 | | 01001001 |
| | | 0_1001110 | | 01001110 |
| | | 1_1000101 | | 11000101 |
| <City>GREENVILLE | GREEN- | 0_1000111 | GREEN- | 01000111 |
| </City> | VILLE | 0_1010010 | VILLE | 01010010 |
| | | 0_1000101 | | 01000101 |
| | | 0_1000101 | | 01000101 |
| | | 0_1001110 | | 01001110 |
| | | 0_1010110 | | 01010110 |
| | | 0_1001001 | | 01001001 |
| | | 0_1001100 | | 01001100 |
| | | 0_1001100 | | 01001100 |
| | | 1_1000101 | | 11000101 |
| <State>TX</State> | TX | 0_1010100 | 4 (TX) | 1 001 0100 |
| | | 1_1011000 | | |
| <Zip_Code>75402</Zip_ | 75402 | 0_0000100 | 75402 | 00000100 |
| Code> | | 0_1001101 | | 01001101 |
| | | 1_0001010 | | 10001010 |
| </Delivery_Address> | | | | |
| <Package_Delivery | Iter = 1 | 1_0000001 | Iter = 1 | 10000001 |
| element_iterations=″1″> | | | | |
| <Box> | | | | |
| <Dimensions> | | | | |
| <Width unit=″INCHES″ | 5 | 1_0000101 | 5 | 10000101 |
| value_qualifier=″LESS_ | | | | |
| THAN″>5</Width> | | | | |
| | Exp. | 0_0000000 | Exp. | 00000000 |
| | 0 | 0_0000000 | 0 | 00000000 |
| | Qual: ‘<’ | 1_1000000 | Qual: ‘<’ | 11000000 |
| <Depth unit=″CM″ | 60 | 1_0111100 | 60 | 10111100 |
| value_qualifier=″LESS_ | | | | |
| THAN″>60</Depth> | | | | |
| | E0 | 0_0000000 | E0 | 00000000 |
| | HasUnits | 0_1000000 | HasUnits | 01000000 |
| | Qual: ‘<’ | 1_1000000 | Qual: ‘<’ | 11000000 |
| | Unit = | 1_0000010 | Unit = | 10000010 |
| | 2(CM) | | 2(CM) | |
| <Height | 2000 | 0_0001111 | 2000 | 00001111 |
| unit=″INCHES″>2000 | | 1_1010000 | | 11010000 |
| </Height> | | | | |
| | E0 | 1_0000000 | E0 | 10000000 |
| </Dimensions> | | | | |
| <Weight unit=″KG″ | 250 | 0_0000001 | 250 | 00000001 |
| accuracy=″2″ value_ | | 1_1111010 | | 11111010 |
| qualifier=″LESS_THAN″> | | | | |
| 250</Weight> | | | | |
| | E0 | 0_0000000 | E0 | 00000000 |
| | Acc & | 0_1100000 | Acc & | 01100000 |
| | Unit | 1_1000000 | Unit | 11000000 |
| | KG | 1_0000010 | KG | 10000010 |
| | Acc = 2 | 1_0000010 | Acc = 2 | 10000010 |
| | E0 | 1_0000000 | E0 | 10000000 |
| </Box> | | | | |
| <Handling_Instructions | RESET | 0_0000000 | RESET | 00000000 |
| reset=″Y″> | | | | |
| <Fragile reset=″Y″/> | | | | |
| <Upright_Only reset=″Y″/> | | | | |
| <Two_Man_Lift reset= | | | | |
| ″Y″/></Handling_ | | | | |
| Instructions> | | | | |
| <Receipt_Instructions> | OP NO | 1_1011101 | OP NO | 11011101 |
| | YES | | YES | |
| <Open_Instructions> | | | | |
| OPEN_IMMEDIATELY | | | | |
| </Open_Instructions> | | | | |
| <Additional_Boxes>NO | | | | |
| </Additional_Boxes> | | | | |
| <Private> YES</Private> | | | | |
| </Receipt_Instructions> | | | | |
| <Tracking_Number> | ADG | 0_1000001 | ADG | 01000001 |
| ADG76</Tracking_ | | 0_1000100 | | 01000100 |
| Number> | | 1_1000111 | | 11000111 |
| | 76 | 1_1001100 | 76 | 11001100 |
| </Package_Delivery> | | | | |
| <Delivery_Address> | | | | |
| <Street>456 MAPLE | 456 | 0_0110100 | 456 | 00110100 |
| </Street> | <Blank> | 0_0110101 | <Blank> | 00110101 |
| | MAPLE | 0_0110110 | MAPLE | 00110110 |
| | | 0_0100000 | | 00100000 |
| | | 0_1001101 | | 01001101 |
| | | 0_1000001 | | 01000001 |
| | | 0_1010000 | | 01010000 |
| | | 0_1001100 | | 01001100 |
| | | 1_1000101 | | 11000101 |
| <City>HAMBURG</City> | HAM- | 0_1001000 | HAM- | 01001000 |
| | BURG | 0_1000001 | BURG | 01000001 |
| | | 0_1001101 | | 01001101 |
| | | 0_1000010 | | 01000010 |
| | | 0_1010101 | | 01010101 |
| | | 0_1010010 | | 01010010 |
| | | 1_1000111 | | 11000111 |
| <State> AR</State> | AR | 0_1000001 | 3 (AR) | 1 001 0011 |
| | | 1_1010010 | | |
| <Zip_Code>71234</Zip_ | 71234 | 0_0000100 | 71234 | 00000100 |
| Code> | | 0_0101100 | | 00101100 |
| | | 1_1000010 | | 11000010 |
| </Delivery_Address> | | | | |
| </Package_Information> | | | | |
| </Report_Content> | | | | |
| <Report_Content> | Tag = 3 | 1_0000011 | Tag = 3 | 0011 |
| | Length | 1_0000111 | Length | 10001011 |
| <Transportation_Type> | Tag = 4 | 1_0000100 | Tag = 1 | 0001 |
| | Length | 1_0000101 | Length | 10001000 |
| <Airplane> | Tag = 6 | 1_0000110 | Tag=2 | 0010 |
| <Flight_Hours>20</Flight_ | 20 | 1_0010100 | 20 | 10010100 |
| Hours> | | | | |
| | E0 | 1_0000000 | E0 | 10000000 |
| <ID_Number> 120</ID_ | 120 | 1_1111000 | 120 | 11111000 |
| Number> | | | | |
| <Flight_Type>NON_STOP | NON_ | 1_0000000 | NON_ | 0001 |
| </Fligth_Type> | STOP | | STOP | |
| </Airplane> | | | | |
| </Transportation_Type> | | | | |
| </Report_Content> | | | | |
| </CMF_Doc> | | | | |

What is claimed is:

1. An apparatus comprising:
data storage to store a document type definition (DTD) and an extensible markup language (XML) representation compatible with standard XML, and which includes element start tags, element end tags, and element values having integer values assigned thereto by the DTD;
a parser to access the XML representation and the DTD, and quadbit encode the integer values for the element start tags and the element values, but not the element end tags, into quadbits that form an extensible binary representation of the XML representation, wherein each quadbit includes one or more half-bytes of binary values, a sum of the one or more half-bytes is equal to a corresponding integer value, and a full half-byte indicates a follow-on half-byte for the corresponding integer value, which provides extensible encoding for each quadbit;
a packager to package the quadbits for the integer values into data packets; and
a communication interface to transmit a data stream including the data packets over a data channel.

2. The apparatus of claim 1, wherein:
the full half-byte further indicates a maximum binary value for a half-byte.

3. The apparatus of claim 1, wherein:
the DTD defines a context sensitive tag relationship between a parent element and a child element that is nested under the parent element in the XML representation, wherein the context sensitive tag relationship limits a scope of an integer value assigned to the child element by the DTD to the parent element, such that the integer value is only locally unique under the parent element and is available for unambiguous assignment to other elements of the XML representation that are not under the parent element.

4. The apparatus of claim 1, wherein:
the XML representation further includes a character string to which an enumerated value is assigned by the DTD;
the parser is configured to quadbit encode the enumerated value into a corresponding quadbit; and
the packager is configured to package the corresponding quadbit for the enumerated value into the data packets.

5. The apparatus of claim 1, wherein:
the XML representation includes a character string of one or more characters;
the parser is configured to encode the character string by:
accessing, in the DTD, an enumerable string transmit list having assignments of character strings to values that are integers;
determining whether the enumerable string transmit list includes an assignment of the character string to a value; and
depending on a result of determining, encoding the character string into a binary string representation that is either (i) an enumerated substitution integer that conveys the value, or (ii) one or more ASCII characters values that represent the one or more characters; and
the packager is configured to package the binary string representation into the data packets.

6. The apparatus of claim 5, wherein:
the parser is further configured to encode the character string by, upon determining that the enumerable string transmit list includes the assignment of the character string to the value, encoding the character string as the enumerated substitution integer that conveys the value.

7. The apparatus of claim 6, wherein:
the enumerable substitution integer is one byte that includes a first field to carry an indicator for the enumerated substitution integer, and a second field to carry the value.

8. The apparatus of claim 5, wherein:
the parser is further configured to encode the character string by, upon determining that the enumerable string transmit list does not include the assignment of the character string to the value, encoding the one or more characters as one or more one-byte ASCII character values.

9. A method comprising:
storing a document type definition (DTD) and an extensible markup language (XML) representation compatible with standard XML, and which includes element start tags, element end tags, and element values having integer values assigned thereto by the DTD;
accessing the XML representation and the DTD, and quadbit encoding the integer values for the element start tags and the element values, but not the element end tags, into quadbits that form an extensible binary representation of the XML representation, wherein each quadbit includes one or more half-bytes of binary values, a sum of the one or more half-bytes is equal to a corresponding integer value, and a full half-byte indicates a follow-on half-byte for the corresponding integer value, which provides extensible encoding for each quadbit;
packaging the quadbits for the integer values into data packets; and
transmitting a data stream including the data packets over a data channel.

10. The method of claim 9, wherein:
the full half-byte further indicates a maximum binary value for a half-byte.

11. The method of claim 9, wherein:
the DTD defines a context sensitive tag relationship between a parent element and a child element that is nested under the parent element in the XML representation, wherein the context sensitive tag relationship limits a scope of an integer value assigned to the child element by the DTD to the parent element, such that the integer value is only locally unique under the parent element and is available for unambiguous assignment to other elements of the XML representation that are not under the parent element.

12. The method of claim 9, wherein the XML representation further includes a character string to which an enumerated value is assigned by the DTD, and the method further comprises:
quadbit encoding the enumerated value into a corresponding quadbit; and
packaging the corresponding quadbit for the enumerated value into the data packets.

13. The method of claim 9, wherein the XML representation includes a character string of one or more characters, and the method further comprises;
encoding the character string by:
accessing, in the DTD, an enumerable string transmit list having assignments of character strings to values that are integers;
determining whether the enumerable string transmit list includes an assignment of the character string to a value; and
depending on a result of determining, encoding the character string into a binary string representation that is either (i) an enumerated substitution integer that conveys the value, or (ii) one or more ASCII characters values to represent the one or more characters; and
packaging the binary string representation into the data packets.

14. The method of claim 13, wherein:
encoding the character string further includes, upon determining that the enumerable string transmit list includes the assignment of the character string to the value, encoding the character string into the enumerated substitution integer that conveys the value.

15. The method of claim 14, wherein:
the enumerated substitution integer is one byte that includes a first field to carry an indicator for the enumerated substitution integer, and a second field to carry the value.

16. The method of claim 13, wherein:
encoding the character string further includes, upon determining that the enumerable string transmit list does not include the assignment of the character string to the value, encoding the one or more characters as one or more one-byte ASCII character values.

17. A method comprising:
storing a document type definition (DTD);
receiving, over a data channel, a stream of data packets that convey a binary representation of an extensible markup language (XML) representation that is compatible with standard XML and that includes element start tags, element end tags, and element values to which integer values are respectively assigned by the DTD, wherein the integer values for the element start tags and the element values, but not the element end tags, are encoded into quadbits of the binary representation, wherein each quadbit includes one or more half-bytes of binary values, a sum of the one or more half-bytes is equal to a corresponding integer value, and a full half-byte indicates a follow-on half-byte for the corresponding integer value;
unpack the data packets of the binary representation to recover the quadbits;
decoding the quadbits into corresponding ones of the integer values;
converting the integer values to the XML representation; and
providing the XML representation as an output.

18. The method of claim 17, wherein:
the DTD defines a context sensitive tag relationship between a parent element and a child element that is nested under the parent element in the XML representation, wherein the context sensitive tag relationship limits a scope of an integer value assigned to the child element by the DTD to the parent element, such that the integer value is only locally unique under the parent element and is available for unambiguous assignment to other elements of the XML representation that are not under the parent element.

19. The method of claim 17, wherein the XML representation conveyed by the binary representation includes a character string that is assigned to an enumerated value by the DTD and encoded in the binary representation as a quadbit, and the method further comprises:
decoding the quadbit to recover the enumerated value, and convert the enumerated value to the character string of the XML representation using the DTD.

20. The method of claim 17, wherein the XML representation conveyed by the binary representation includes a character string that is encoded as a binary string representation in the binary representation, and the method further comprises:
upon determining that the binary string representation indicates that the binary string representation includes a value for the character string, using the value to retrieve the character string from an enumerable string receiver list of the DTD which includes an assignment of the value to the character string.
